(19) United States
(12) Patent Application Publication
(10) Pub. No.: US 2025/0291700 A1
(43) Pub. Date: Sep. 18, 2025

(54) DETECTING ANOMALIES IN LOG MESSAGES USING CODE-DERIVED MESSAGE PATTERNS TO GUIDE STRUCTURED MESSAGE CLASSIFICATION

(71) Applicant: Oracle International Corporation, Redwood Shores, CA (US)

(72) Inventors: Raghu Vamshi Hemadri, Karnataka (IN); Arjun Upadhyay, Redwood Shores, CA (US); Girish Adiga Sathyanarayana, Redwood Shores, CA (US); Sandesh Rao, Redwood Shores, CA (US); Angelo Pruscino, Redwood Shores, CA (US)

(73) Assignee: Oracle International Corporation, Redwood Shores, CA (US)

(21) Appl. No.: 18/608,187

(22) Filed: Mar. 18, 2024

(51) Int. Cl. G06F 11/34; G06F 40/268

(52) U.S. Cl. CPC G06F 11/3476; G06F 40/268

(57) ABSTRACT

Computer systems and processes are described herein for using code-derived message patterns to determine whether or not to trigger an anomaly notification. A system manager trains a pattern matching model and an anomaly detection model based on historical log messages, feedback about historical log messages, and message-generating portions of source code that generated the log messages. The message-generating portions of code may be processed to determine code-derived message patterns for a type of log messages. A log processor receives a message and determines the message is of the type for which code-derived message patterns are available. The message is matched to one of the available code-derived message patterns, and the log processor determines whether or not to trigger an anomaly notification based at least in part on which code-derived message pattern is matched to the message.

### BACKGROUND

Computer systems, network-connected systems, and other machines are designed to perform functionality, often including repetitive tasks or sub-tasks that are performed multiple times but with a changing context depending on the scenario. Many computer systems are designed to use underlying hardware, which supports a finite set of operations that can be performed with different input contexts, as well as underlying software language platforms, which use the underlying hardware to support higher-level special-purpose operations. Systems can accomplish a wide range of functionality using special-purpose software that was designed to perform tasks in a methodical and beneficial manner.

Even in simple computer systems, hardware operations and higher-level software operations may be performed at such high speeds and in such vast quantities that no human can follow every operation that is performed even for a short period of time. In complex computer systems with multiple hardware and software systems operating together, there is little visibility into the hardware-level operations and software-level operations that are occurring beyond whether the resulting functionality appears to be achieved. For example, loading a web page may involve thousands or millions of hardware and/or software operations, depending on the web page, but a user has little knowledge of the precise operations that occurred when the web page was loading beyond whether the web page actually loaded. All of these operations typically occur within milliseconds after the user has requested, through a browser, for the web page to load.

System monitoring components may help a web page administrator keep track of how many times the web page loaded and how many times the web page was requested but did not load. Such high-level metrics may be helpful for the web page administrator to determine whether the system might be malfunctioning, but the web page administrator does not actually know whether finer-grained problems are occurring that are causing the system to perform poorly or otherwise unexpectedly.

Status messages, error messages, system state messages, transaction reporting messages, and other log messages may be generated as the system operates to perform tasks, leaving a trail of information about what has occurred in the system. Single messages, tens of messages, hundreds of messages, or even thousands or millions of messages, for example, may be generated as a single task is performed, and systems may be performing tasks every microsecond, millisecond, second, minute, or hour, for example, depending on the system and task.

Further, log messages may or may not make sense to a human reviewer who has no capability to keep up with system activity. Log messages are often designed to be generated efficiently and with minimal overhead, while providing rich information that explains what the system is doing at each significant step.

Based on the volume and type of content in log messages, system administrators have little hope of detecting problems before the problems result in preventing the system from performing user-facing functionality. Even for problems that result in preventing the system from performing user-facing functionality, the system administrator may not be aware of those problems unless the administrator is looking at metrics and system activity specifically and directly linked to the user-facing functionality. Even then, such metrics generally do not cover all user-facing functionality, as the functionality offered by complex systems is often widely variant and depends on a variety of software components to operate correctly together. The administrator may not have a good understanding of what software components were working together on a specific task for a specific user, let alone what software components were operating together on a variety of tasks for a variety of users over time.

### BRIEF SUMMARY

In various embodiments, computer systems and processes are described herein for using code-derived message patterns to determine whether or not to trigger an anomaly notification. A system manager trains a pattern matching model and an anomaly detection model based on historical log messages, feedback about historical log messages, and message-generating portions of source code that generated the log messages. The message-generating portions of code may be processed to determine code-derived message patterns for a type of log messages. A log processor receives a message and determines the message is of the type for which code-derived message patterns are available. The message is matched to one of the available code-derived message patterns, and the log processor determines whether or not to trigger an anomaly notification based at least in part on which code-derived message pattern is matched to the message.

In one embodiment, a computer-implemented method includes determining a plurality of code-derived message text patterns from one or more source code files that generate messages of one or more types. Determining the plurality of code-derived message text patterns may further include detecting message generating instructions in the one or more source code files that generate messages of the one or more types, and determining that the message generating instructions generate messages according to the plurality of code-derived message text patterns, wherein one or more of the plurality of code-derived message text patterns comprise invariant text and placeholders for variable text. The method further includes receiving a set of one or more messages, and determining a particular message of the one or more messages is at least one type of the one or more types. The method determines one or more code-derived message text patterns of the plurality of code-derived message text patterns available for the at least one type. The method further includes matching the particular message to a particular code-derived message text pattern of the one or more code-derived message text patterns. Based at least in part on the one or more code-derived message text patterns, the method determines whether the particular message is anomalous. Then, based at least in part on determining that the particular message is anomalous, the method triggers a notification that the particular message is anomalous.

In a further embodiment, the step of matching the particular message to the particular code-derived message text pattern of the one or more code-derived message text patterns includes using a drain having a fixed maximum depth to determine a particular text pattern for the particular message, and matching the particular text pattern to the particular code-derived message text pattern.

In another embodiment, the step of matching the particular message to the particular code-derived message text pattern of the one or more code-derived message text patterns includes using a first drain portion having a fixed maximum depth to determine a first particular text pattern for the particular message. The first particular text pattern accounts for a first part of the particular message but not a second part of the particular message. The step of matching the particular message to the particular code-derived message text pattern of the one or more code-derived message text patterns further includes determining that the first particular text pattern matches two or more code-derived message text patterns including the particular code-derived message text pattern and another code-derived message text pattern. Further, the step of matching the particular message to the particular code-derived message text pattern of the one or more code-derived message text patterns includes using a second drain portion having a fixed maximum depth to determine a second particular text pattern for the particular message. The second particular text pattern accounts for the second part of the particular message. Then, the step of matching the particular message to the particular code-derived message text pattern of the one or more code-derived message text patterns includes determining that the second particular text pattern matches the particular code-derived message text pattern and not the other code-derived message text pattern.

In another embodiment, the step of matching the particular message to the particular code-derived message text pattern of the one or more code-derived message text patterns includes determining a particular text pattern for the particular message using a message classifier having a computational complexity that does not increase beyond a fixed maximum even though the message classifier classifies messages that have a variable length including a variable amount of invariant text and placeholders, and matching the particular text pattern to the particular code-derived message text pattern.

In another embodiment, the step of matching the particular message to the particular code-derived message text pattern of the one or more code-derived message text patterns includes determining a first particular text pattern for the particular message using a first message classifier component having a computational complexity that does not increase beyond a fixed maximum even though the first message classifier component classifies messages that have a variable length including a variable amount of invariant text and placeholders. The first particular text pattern accounts for a first content variability of the particular message but not a second content variability of the particular message. The step of matching the particular message to the particular code-derived message text pattern of the one or more code-derived message text patterns further includes determining that the first particular text pattern matches two or more code-derived message text patterns including the particular code-derived message text pattern and another code-derived message text pattern. Further, the step of matching the particular message to the particular code-derived message text pattern of the one or more code-derived message text patterns includes determining a second particular text pattern for the particular message using a second message classifier component having a computational complexity that does not increase beyond a fixed maximum even though the second message classifier component classifies messages that have a variable length including a variable amount of invariant text and placeholders. The second particular text pattern accounts for the second content variability of the particular message. Then, the step of matching the particular message to the particular code-derived message text pattern of the one or more code-derived message text patterns includes determining that the second particular text pattern matches the particular code-derived message text pattern and not the other code-derived message text pattern.

In another embodiment, the step of matching the particular message to the particular code-derived message text pattern of the one or more code-derived message text patterns includes determining a particular text pattern for the particular message, and determining that the particular text pattern exists in a set of stored text patterns, wherein the set of stored patterns comprises a stored association between the particular text pattern and the particular code-derived message text pattern.

In another embodiment, the step of matching the particular message to the particular code-derived message text pattern of the one or more code-derived message text patterns includes determining a particular text pattern for the particular message using a message classifier having a computational complexity that does not increase beyond a fixed maximum even though the message classifier classifies messages that have a variable length including a variable amount of invariant text and placeholders. The step of matching the particular message to the particular code-derived message text pattern of the one or more code-derived message text patterns further includes determining that the particular text pattern matches two or more code-derived message text patterns including the particular code-derived message text pattern and another code-derived message text pattern, and determining that the particular message does not include one or more items of invariant text in the other code-derived message text pattern.

In another embodiment, the step of determining whether the particular message is anomalous based at least in part on the one or more code-derived message text patterns includes determining that the one or more code-derived message text patterns infrequently occur among the plurality of code-derived message text patterns.

In the same or a different embodiment, the step of determining whether the particular message is anomalous based at least in part on the one or more code-derived message text patterns includes determining that the particular code-derived message text pattern is reporting an anomaly based at least in part on a label generated by prompting a large language model to label the particular message, the particular code-derived message text pattern, or particular message generating instructions of the message generating instructions.

In the same or a different embodiment, the step of determining whether the particular message is anomalous based at least in part on the one or more code-derived message text patterns includes determining that the one or more code-derived message text patterns have been stored in a set of code-derived message text patterns that are marked as anomalous.

In various aspects, a system is provided that includes one or more data processors and a non-transitory computer-readable storage medium containing instructions which, when executed on the one or more data processors, cause the one or more data processors to perform part or all of one or more methods disclosed herein.

In various aspects, a computer-program product is provided that is tangibly embodied in a non-transitory machine-readable storage medium and that includes instructions configured to cause one or more data processors to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 shows a flow chart depicting a process for using code-derived message patterns to determine whether or not to trigger an anomaly notification.

FIG. 2 illustrates a diagram of a system for using code-derived message patterns to determine whether or not to trigger an anomaly notification.

FIG. 3 illustrates a multi-level classification object for determining which one or more code-derived message patterns match an incoming message.

FIGS. 4A and 4B illustrate multi-level classification objects modified to determine more distinctly which one or more code-derived message patterns match an incoming message.

FIG. 5 depicts a simplified diagram of a distributed system for implementing certain aspects.

FIG. 6 illustrates an example computer system that may be used to implement certain aspects.

### DETAILED DESCRIPTION

Computer systems and processes are described herein for using code-derived message patterns to determine whether or not to trigger an anomaly notification. A system manager trains a pattern matching model and an anomaly detection model based on historical log messages, feedback about historical log messages, and message-generating portions of source code that generated the log messages, and the system manager uses code-derived message patterns to determine whether or not to trigger an anomaly notification. The system manager is a software tool that runs on a computer system to manage log message sources and anomaly detection and notification policies that may be specific to individual users or tenants for the log message sources. Due to the high rate by which log messages stream into the system manager from various sources, analysis and policies are efficiently managed to balance throughput of log message processing with quality of log message processing.

In various embodiments, the method for using code-derived message patterns to determine whether or not to trigger an anomaly notification is implemented using non-transitory computer-readable storage media to store instructions which, when executed by one or more processors of a computer system, cause display of the user interface and processing of the received input to view anomalies, provide feedback, and/or drill into labeled log messages. The method for using code-derived message patterns to determine whether or not to trigger an anomaly notification may be implemented on a local or cloud-based computer system that includes processors and one or more monitored software and/or hardware systems generating log messages.

A description of the method for using code-derived message patterns to determine whether or not to trigger an anomaly notification is provided in the following sections:
REGISTERING LOG MESSAGE SOURCES
PARSING SOURCE CODE TO FIND MESSAGE-GENERATING CODE SNIPPETS
GENERATING SIGNATURES FOR POTENTIAL OUTPUTS OF THE MESSAGE-GENERATING CODE SNIPPETS
LABELING POTENTIAL OUTPUTS OF THE MESSAGE-GENERATING CODE SNIPPETS
REDUCING INCOMING LOG MESSAGES TO PATTERNS AND MATCHING TO CODE-DERIVED SIGNATURES IN A RESOURCE-CONSTRAINED PROCESS
MULTI-LEVEL MATCHING WITH CAPPED COST ADAPTIVE DEPTH CLASSIFICATION.
PATTERN MATCHING AND ANOMALY DETECTION METRICS
DETECTING ANOMALIES FROM INCOMING LOG MESSAGES
AUTOMATIC ACTION RESPONSIVE TO ANOMALIES

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Registering Log Message Sources

Message sources may be registered with a system manager to define how messages are stored and processed as they are generated by various system components and stored for analysis by a log processor, which may be a subsystem of the system manager or a separate component that consumes data pipelines managed by the system manager. As used herein, “messages” may refer to individual lines of a log file, a log message object that includes multiple lines, or any other message about system activity that could indicate whether or not the system activity is anomalous or not. The messages may be generated as status messages, error messages, system state messages, transaction reporting messages, and other log messages where a system component or an agent monitoring the system component is reporting on system component activity or state. Messages from a variety of sources may be registered with the system manager by registering each source in a library of sources, with the registration identifying metadata about the data stream such as a network or local source or address from which the information is received, a certificate, key, password, or other credentials associated with a connection or access to the information, a type of information being received, and/or a location or content of a source code file of software that generates the information.

In one example, message sources or portions of message sources may be registered as having a particular file or message type. Files may include one or more messages corresponding to the file type. An example file may include hundreds or thousands of different messages having different message patterns but all corresponding to the same file or message type. For example, different files of different types written by different software components within clusterware may each include messages of corresponding types. Example file types include, but are not limited to, cluster synchronization service files (CSS), cluster ready services files (CRS), cluster health monitor files (CRF), event management files (EVM), cluster time synchronization service daemon files (CTSSD), or automatic storage management cluster file system files (ACFS). These example file types include messages of the CSS message type, CRS message type, CRF message type, EVM message type, CTSSD message type, and ACFS message type, respectively. A single software component may generate files or messages of different types in different portions of the software component, or a software component may have several processes that generate files or messages of a single type. In one example, all files or messages generated by a software component are labeled with the same file or message type. For example, the cluster synchronization service generates files or messages that are called a cluster synchronization service type. In another example, if a single software component generates files or messages of different types, the single software component may be labeled with all of the different types that may be generated by the software component rather than just one type.

A user registering the message source with the system manager may also specify a path to source code or contents of source code that produces files or messages of the given type or types as well as any information needed to maintain a data pipeline for locating and accessing or otherwise receiving the files once generated.

Different types of files or messages may have different message patterns that are common to the type, and/or have a consistent meaning within the type. In this manner, the type may serve as a first way to distinguish different messages that have different underlying contexts. For example, one block of code may report transactions that have been completed in messages having a same structured message format each time, and another block of code may report on transactions that have been completed using a different structured message format but also consistent within the other block of code. The formats may overlap between different blocks of code and have different meanings depending on which block of code originated the message. When a source is registered, these different formats associated with the source may be distinguished from overlapping formats associated with other sources so different meanings may be inferred from messages that otherwise look similar to each other, based on information about the originating block of code or other type information for the message.

In one embodiment, various messages have the same file extensions, such as “.msg”, “.trc”, “.log”, or “.txt,” but they are stored in association with different message types even though the files themselves share the same extension. The file extension may indicate how the data within the file is stored in computer memory, so that the textual contents of the file may be opened; whereas, the type of message may indicate where the message originated or for what type of services the message reports on.

Metadata may be stored for a registered source of messages to indicate the type of messages coming from the registered source, even if the type of message is not indicated by the file extension. The filename or file path may also contain information about the type of messages generated from the source. For example, the path from which the messages originate may indicate whether the messages are “CSS” messages or “CRS” messages based on the corresponding type being used as a folder or directory name in the path, or the path where the messages are at least initially saved, before being further processed, may indicate whether the messages are “CSS” messages or “CRS” messages based on the corresponding type being used as a folder or directory name in the path. In one example, such path or file name information is provided according to naming conventions for log messages to promote efficient management of the type information in the same manner for each file. The metadata may also be stored as a header of the file containing the message(s), or in a table in association with the file containing the message(s).

In one embodiment, instead of registering a type for a new data source, the type is learned based on an analysis of messages coming from the source and/or based on an analysis of code producing the messages. Sources that produce similar messages or that come from similar code having similar code-derived message patterns may be clustered together, and the resulting cluster may serve as the type for the message. Regardless of how the type is determined, the type is useful for filtering down the number of code-derived message patterns that are available to match incoming messages from different sources based on characteristics other than the contents of the individual messages themselves, such as the source of the messages.

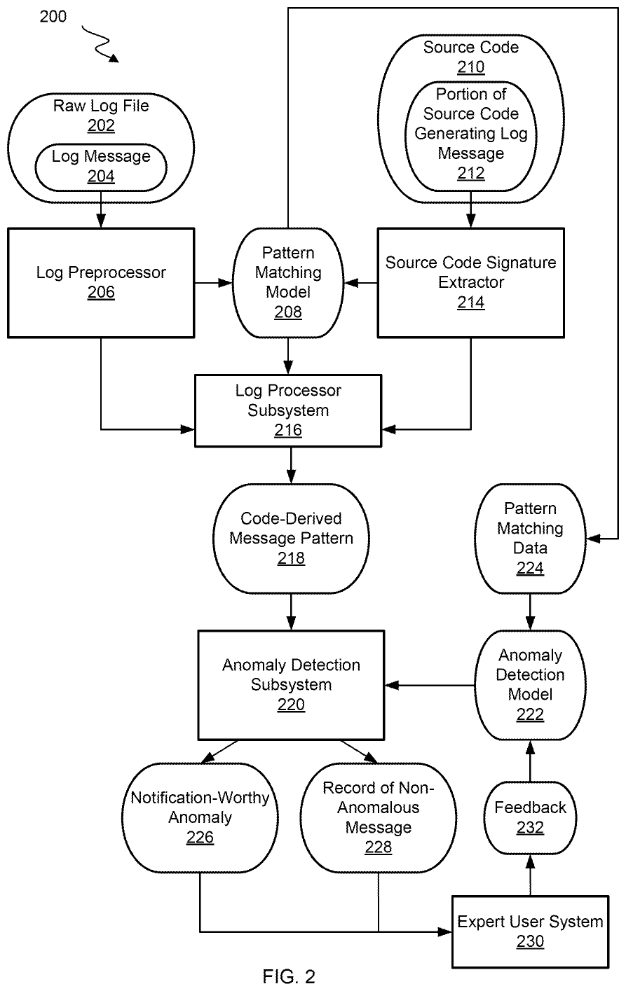

FIG. 2 shows a system for using code-derived message patterns to determine whether or not to trigger an anomaly notification. As shown, a raw log file 202 including a log message 204 is provided to log preprocessor 206. For example, such file may be provided according to registered data storage and access pipelines for the source of messages. During a training phase, log preprocessor 206 prepares the log for use in training pattern matching model 208. During production, log preprocessor 206 prepares the log for analysis by the log processor subsystem using pattern matching model 208, which may account for code-derived message patterns as described herein.

### Parsing Source Code to Find Message-Generating Code Snippets

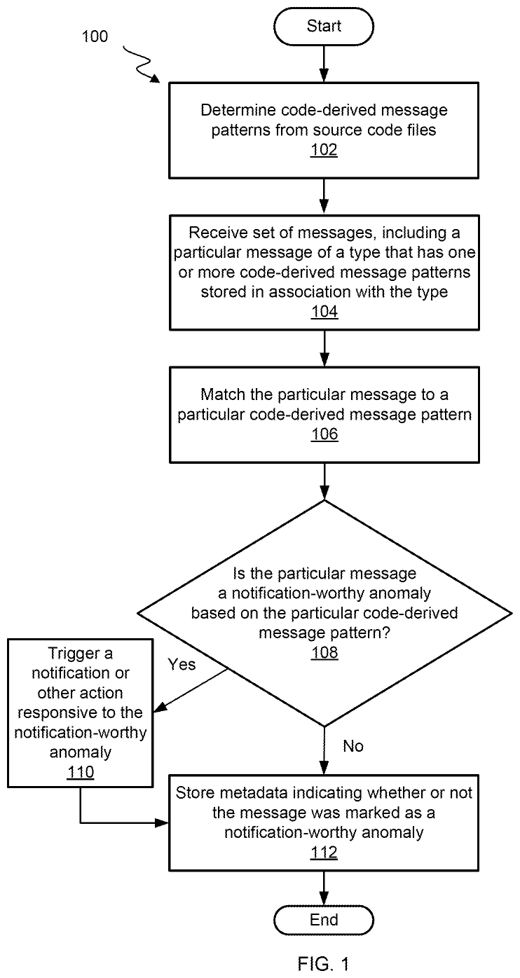

As shown in FIG. 1, a process 100 for using code-derived message patterns to determine whether or not to trigger an anomaly notification begins in block 102 with determining code-derived message patterns for source code files. Determining the code-derived message patterns may include parsing source code to find message-generating code snippets or portions and determining what patterns of messages the message-generating code snippets or portions generate. The code-derived message patterns determined from the message-generating code snippets or portions may be stored in association with the source type, such that different source types have different candidate code-derived message patterns.

Referring back to FIG. 2, system 200 includes source code 210, which includes a portion of source code generating a log message 212. The portion is used by source code signature extractor 214 to determine code-derived message patterns for use in matching against incoming log files. The code-derived message patterns are included in pattern matching model 208 for use in a training phase of building a classification model to ensure that the code-derived message patterns are covered in fine enough granularity to satisfy one or more matching accuracy conditions (e.g., a 4:1, 3:1, 2:1, or 1:1 mapping with the incoming message patterns). The code-derived message patterns as mapped to the incoming message patterns are reflected in pattern matching model 208 for use during production by log processor subsystem 216 to match incoming log message patterns to code-derived message patterns.

Once pattern matching model 208 has been trained to recognize code-derived message patterns to satisfy one or more matching accuracy conditions, log messages may be received and classified by pattern matching model 208. A given message may be received and pre-processed to clean the message and match the message to a source type. Pattern matching model 208 may include a plurality of message patterns mapped to code-derived message patterns for the given source type. A text pattern of the message may then be matched to a code-derived message text pattern of the source type based on the code-derived message patterns stored in association with the source type.

Determining code-derived message patterns involves an analysis of the underlying source code that generates log messages. In one embodiment, a path to source code is identified when a message source is registered. The source code is accessed at the path and parsed to determine whether there are any messages generated by the source code. Different forms of source code may be used to generate messages, and these different forms are analyzed using rules that may be specific to the language of the source code. In various examples, source code may be analyzed for Python, C++, C, Shell, Perl, Java, JavaScript, Swift, Go, Kotlin, Rust, TypeScript, PHP, Ruby, SQL, Scala, C #, Matlab, Dart, Julia, and/or Assembly to determine whether files, rows, or data objects are being generated and, if so, whether they qualify as messages or not based on zero or more additional conditions. Functions such as print, fprintf, fputs, open or fopen in write or append mode, write, append, etc, may be found to indicate a file is being generated. Additional conditions may be checked to determine whether the file is a log message, such as whether the file being generated by the function is being saved in a location, directory, or with a naming convention associated with log messages, or if the file is being sent to or from a node associated with sending or receiving log messages. The output or write functions and additional conditions may vary depending on the programming language and the computer architecture of the log message generating system.

Using the source code to determine message patterns may improve the accuracy of clustering messages, as messages having differences that are not driven by source code structure (for example, differences due to different variable values) may be clustered together when they otherwise would have appeared different. For source code extracted from clusterware components, a common communication library, such as grid interprocess communication (GIPC), may be used to identify the components using the library to generate messages. The system manager may identify meaningful lines of code from these log-contributing lines.

The extracted source code portions are useful in evaluating message patterns or clusters of incoming messages by labeling the dataset with which extracted source code portion contributed to each message during training, and using a trained model to label and classify messages based on their corresponding source code during production. This approach mitigates many limitations inherent in fully supervised learning mechanisms for cluster evaluation, since the code-derived message patterns are rooted in the source code.

The integration of source-code mapping brings forth several potential example advantages:

1. Generic Cluster Identification: With source-code associations, generic clusters may be identified. These clusters encompass multiple portions of source code, indicating that the generic cluster may actually cover a mix of different messages with different intended behavior and some similar messages with similar intended behavior. In one embodiment, message pattern clusters mapped to more than four portions of source code and/or code-derived patterns from those portion(s) are identified as generic templates and trigger a further refinement of using additional levels of pattern comparison for distinguishing between the different mapped code-derived patterns.

2. Refined Template Formation: The presence of source-code information empowers the log processor to cluster messages that match code-derived patterns and subsequently create more nuanced message patterns or cluster templates. These more nuanced message patterns may be covered in multi-level clustering strategies with a better understanding of the cost and benefit of extending clustering strategies to additional levels.

### Generating Signatures for Potential Outputs of the Message-Generating Code Snippets

In one embodiment, the system manager determines that the message generating instructions in the portion(s) of source code generate messages according to code-derived message text patterns. The code-derived message text patterns may include many patterns with both invariant text and placeholders for variable text. Some patterns may have only invariant text or placeholder(s) for variable text.

In order to determine what is being written, a variable may need to be unwrapped to incorporate the variable's disparate parts. For example, the source code may print a string variable, “var_str1,” and the string variable may be updated by various lines of code. For example, the string may be initialized as “var_str1=“ ”, and appended to as “var_str1=var_str1+var_str2,” based on another string, var_str2, that was previously assigned a value, “var_str2=‘error:’”. The string may be further appended by other values, which may be cast as strings. For example, “var_str1=var_str1+str (var_int1)” concatenates a number to the end of var_str2. The pattern for var_str2 may now be represented as “error: % d,” where % d represents a placeholder for an unknown decimal integer value. Other example placeholders include % s for an unknown string, % c for an unknown character, % o for an octal integer, % x for a hexadecimal integer, % p for an address or pointer, % u for an unsigned decimal, % f for a float value, % e for a floating point number in scientific notation, and % % for the % symbol. The pattern accounting for placeholders may also be called a template, as multiple different placeholder values in combination with the invariant text of the template fit the same template but other text variations with different variable types (e.g., numbers in place of alphabetical characters or alphabetical characters in place of numbers) and/or different invariant text may not fit the template.

Some variables may be conditional on factors that are unknown to the system manager at the time the source code is being analyzed, or factors that may be known but may alternate in different instantiations of the message. For example, an output string may be written in an IF statement as follows:

if var_int2 == 1:
var_str1 = ‘Success Code: ’ + str(var_int1)
elif var_int2 == 2:
var_str1 = ‘Unknown State’
else:
var_str1 = ‘Error Code: ’ + str(var_int1)
log_file.write(var_str1)

In this example, several different patterns may be detected for the output string, such as “Success Code: % d”, “Unknown State”, and “Error Code: % d”. These patterns may be stored as alternative patterns that may be output as a log message to the log file. In one further embodiment, based on the word “Error” or similar anomaly-indicating words occurring in one form of the message, that message pattern, “Error Code: % d” may be flagged as likely indicating an anomaly.

Another example of a conditional statement that leads to multiple patterns of log messages is output from a try operation and except operation. The try operation may output one form of a log message, and the except operation may output another form of the log message. The different forms may be represented as different patterns. In this example, because the “except” operation is often used to handle unexpected behavior in code, the pattern indicated by the “except” pathway may be flagged as likely indicating an anomaly.

The full library, package, chunk, or set of code may be parsed in this manner to identify outputs, variables of different types feeding into the outputs, and corresponding patterns with type-specific placeholders to indicate variable components and raw characters to indicate invariable components.

Examples of more complex code-derived message patterns include, but are not limited to:
1. clssgmpDispatchWrkToWrkthrd: src % d grock % s, type % d, msgtype % d, thrdnum % d
2. clssgmDispatchCMXMSG: Queueing message type % d msg incarnation % u from node % d for later because queued msgs were found
3. clssgmSystemShutdown: Received notification from proc (% p) that system shutdown was started
4. clssscagProcAgReq: Notifying agents that resource should remain down
5. clssscWaitChangeEventValue: ev (% s) unchanged from % u
6. Status for active % s node % s, number % u: hub rim
7. clssgmGroupAttrPrint: Attributes for group % s, ID % u: % u

As can be seen in the examples above, static or non-variant portions of many of the messages (except message 6) include a message title followed by a “:”. Many of the messages (except message 4) also include key-value pairs where variable names show up as non-variant portions and variable values show up as variant portions with an assigned data type. Example variable names being listed in the messages are (message 1) src, grock, type, msgtype, thrdnum (message 2) queueing message type, msg incarnation, node, (message 3) proc, (message 5) ev, (message 6) node, number, (message 7) group, ID. Some of the messages also include descriptive text connecting the title or key value pairs to provide more detail about what the message is about, such as “from” and “for later because queued msgs were found” in message 2, “Received notification from” and “that system shutdown was started” in message 3, “Notifying agents that resource should remain down” in message 4, “unchanged from” in message 5, “Status for” and “hub rim” in message 6, and “Attributes for” in message 7. These invariant parts of the messages are combined with placeholders for the variant parts of the messages, indicated by “% d”, “% s”, “ou”, and “% p” in these examples, to form the code-derived message patterns. As shown in the examples, the placeholders are type-specific, but the placeholders may also be type-generic.

### Labeling Potential Outputs of the Message-Generating Code Snippets

The code-derived message patterns may further be labeled based on the surrounding code and based on their context, such as a structural context that accounts for where the message occurs within the logical structure of the source code and/or a semantic context that accounts for comments, method or class names, or other explanatory language in the source code that describes a purpose of the message. For example, if the code-derived message pattern was detected in an except block of try-except logic, the code-derived message pattern may be labeled with an “exception” label that may be consumed by a machine learning model to indicate that the code-derived message pattern is more likely to be anomalous even if no actual log messages or actual log message patterns have been labeled accordingly. As another example, the code-derived message pattern may occur in a scenario where an error message pattern does not occur, and the code-derived message pattern may be labeled with “non-error path” to indicate to a machine learning model that the code-derived message pattern is less likely to be anomalous even if no actual log messages or actual log message patterns have been labeled accordingly. In another example, the code-derived message pattern may be triggered by a method named “report_error,” or a method with commenting that says “reporting an error,” in which case the code-derived message pattern may be labeled with “error” to signal to a machine learning model that the code-derived message pattern is likely to be anomalous even if no actual log messages or actual log message patterns have been labeled accordingly. As yet another example, the code-derived message pattern may be generated in a code path along with an expensive operation such as a stack trace or core dump, in which case the code-derived message pattern may be labeled with “stack trace” or “core dump” or “expensive path” to signal to a machine learning model that the code-derived message pattern is likely to be anomalous even if no actual log messages or actual log message patterns have been labeled accordingly, based on the observation that expensive logging operations are typically reserved for anomalous scenarios.

In one embodiment, code-derived message patterns may be labeled using a large language model to understand contents of the code-derived message patterns and/or a context of code generating the code-derived message patterns. For example, the code generating the code-derived message patterns may include comments that indicate one path is to check for an error due to an invalid input and another path occurs when the input is valid. The observed code-derived message pattern may be included in a prompt to a large language model, for example, one including contextual information, such as “The following code snippet generates the following message pattern. Based on the message pattern and the code snippet, please classify the message pattern into one or more of the following categories,” followed by a labeled code-derived message pattern, a labeled code snippet that generated the code-derived message pattern, and/or labeled categories that the LLM can choose from. If there are helpful comments in the code about certain pathways, the LLM may infer the meaning of the message and output a corresponding category or categories that most closely relate to the meaning. The LLM may also be provided, in the prompt, with examples of different messages, message patterns, and/or message generating code in different categories, to improve the accuracy of selecting an appropriate category.

In another embodiment, the LLM may be provided with one or more examples of patterns that match a specific category, such as “error,” and be asked to select from a provided set of messages and/or patterns that also match the specific category.

In another embodiment, the LLM may be provided with one or more examples of messages and/or patterns that match a specific category, such as “core dump,” and be asked to select from a provided set of messages and/or patterns those messages that also match the specific category. In the example below, the prompt may provide a set of messages that are lines of a dump log, and ask the LLM to identify other messages in the set of messages that are also lines of the dump log, so that messages and/or message patterns may be labeled and/or treated accordingly for anomaly detection purposes.

Once the code-derived message patterns have been detected and stored from the source code, future log messages may be analyzed with knowledge of these code-derived message patterns and, if labeled, their labels, even if the code-derived message patterns are so rare that they have never shown up in actual log messages or actual log message patterns. In this way, new log message patterns detected in incoming messages may be matched to known patterns in the code-derived message patterns to provide a context on where the new message is coming from, why the message is so rare, and whether the rarity of the message should give rise to concern and remedial, analytical, or other actions responsive to an anomaly. For example, if the new message is matched with a code-derived message pattern of “expensive path” and/or “error path,” the new message may be more likely to trigger a remedial or analytical action such as a notification and/or a configuration change in the system. On the other hand, if the new message is rare but is matched with a code-derived message pattern of “inexpensive path” and/or “non-error path,” the new message may be less likely to trigger an action responsive to an anomaly. A machine learning model may consume the code-derived message patterns and their labels, as well as actual message patterns and their labels, actual messages and their labels, and other statistics and characteristics in order to determine whether the occurrence of a specific combination of patterns, labels, and/or other characteristics should be treated as anomalous and trigger an action responsive to an anomaly.

In one embodiment, different versions of applications or services may have different sets of code-derived message patterns and/or different labels due to their differences in source code and/or due to differences in labels maintained for different users or tenants. In a multi-tenant system, for example, different combinations of these applications and/or services may be implemented in different environments. For example, a first tenant with a first tenant-system software setup may use service versions A.1, B.2, C.1, and D.2. A second tenant with a second tenant-system software setup may use service versions A.2, B.2, D.2, and E.1. Accordingly, log messages for the first tenant may be analyzed with respect to code-derived message patterns for A.1, B.2, C.1, and D.2, and log messages for the second tenant may be analyzed with respect to code-derived message patterns for A.2, B.2, D.2, and E.1. If a first tenant's log processor receives a log message of a type that is from application A, the first tenant's log processor may attempt to match the message to code-derived message patterns for A.1. If a second tenant's log processor receives a log message of a type that is from application A, the second tenant's log processor may attempt to match the message to different code-derived message patterns for A.2. In the example, either tenant receiving log messages for service B may attempt to match the messages to the same code-derived message patterns for B.2.

Even if different tenant or user systems use the same type of message source that leads to the same code-derived message patterns, the code-derived message patterns may be labeled differently for different tenants or users. What one tenant or user may consider a notification-worthy anomaly with one view or understanding and/or for one purpose, another tenant or user may not consider a notification-worthy anomaly with another view or understanding and/or for another purpose.

### Reducing Incoming Log Messages to Patterns and Matching to Code-Derived Signatures in a Resource-Constrained Process

With a model trained to match messages to code-derived message patterns, process 100 may proceed to match incoming messages. Referring back to FIG. 1, once code-derived message patterns are determined in block 102, process 100 continues to block 104 where a set of messages is received. The set includes a particular message of a type that has one or more code-derived message patterns stored in association with the type. Then, in block 106, the particular message is matched to a particular code-derived message pattern. The particular code-derived message pattern may be selected from a plurality of candidate code-derived message patterns available for the source of the particular message, according to a matching process that explores pattern variances of incoming messages to distinguish between the candidate code-derived message patterns.

In one embodiment, a log parser is used to receive and process incoming messages. The log processor may receive the messages for parsing and further analysis. For example, incoming messages may be stored in a repository for retrieval by the log processor, or may be sent in one or more streams to the log processor. The log processor coordinates with a library of data sources from the system manager to identify which queues of messages are available for processing, based on stored data indicating a source or location of the messages as well as optionally other characteristics of the messages. Up-front information may be known about the log messages before the contents of the messages have been parsed or processed. In one embodiment, incoming log messages are initially classified based on message type, using metadata about the message such as a path or directory from which the message originated or was retrieved, a name of a file or folder containing the message, a header of the message or of a wrapper containing the message, or metadata stored, for example, in a table in association with a file containing the message. Any additional up-front information that may be obtained without parsing the entire contents of the message itself may be used as type information to narrow down the possibilities for what the message might contain.

In one embodiment, an incoming text pattern may have been seen before and previously mapped to a code-derived message text pattern. In this embodiment, the incoming message may be reduced to a pattern, and the log processor may detect that the pattern matches a pattern that has been seen before and is already stored in association with a code-derived message text pattern. The log processor may then return the associated code-derived message text pattern as the matching pattern for the incoming log message, optionally along with any metadata associated with the code-derived message text pattern.

In one embodiment, a drain or any other classification structure that maps incoming message patterns to known code-derived message patterns may be used in one or multiple passes to classify log messages. In one embodiment, the drain uses a single pass to classify streamed data. To reduce the time and the space required to ingest logs, the drain may use a fixed depth tree.

For example, the messages below may be classified using a drain.
08:15:15: STATUS: Connection lost: ID 1038745
08:17:12: EXCEPTION: Connection aborted: ID 1972384
08:18:36: STATUS: Connection lost: ID 1456675
08:19:23: STATUS: Connection lost: ID 1347829
08:23:42: STATUS: Connection lost: ID 1783420

Log cleaning may be performed initially in order to create logs that can be more accurately grouped together. Logs are cleaned according to rules defined by the user or the implementation. One rule may be that a single “:”, “-”, or other punctuation or common delimiters are not tokens.

Common rules may include:
Removing leading and trailing characters
A list of delimiters to define how to split the log
Removing punctuation

In the example, the drain assumes beginning tokens are likely to be constant. To further improve processing of the message, a time pattern may be defined, and times may be replaced with a time placeholder before passing into the drain. Structured headers like timestamp, hostname. severity, etc. may be extracted from log messages before passing to drain, in order to improve accuracy and specificity. In one embodiment, any token containing a digit may be defined as a number variable and grouped using a placeholder such as <NUMCHAR>.

The pre-processed messages including the time placeholder may be as follows:
<time>: STATUS: Connection lost: ID 1038745
<time>: EXCEPTION: Connection aborted due to critical error: ID 1972384
<time>: STATUS: Connection lost: ID 1456675
<time>: STATUS: Connection lost: ID 1347829
<time>: STATUS: Connection lost: ID 1783420

Using the rule that a space character is a delimiter, the messages are processed by breaking up the messages for comparison as follows:

TABLE 1
Token Assignments

| Token1 | Token2 | Token3 | Token4 | Token5 | Token6 | Token7 | Token8 | Token9 |
|---|---|---|---|---|---|---|---|---|
| <time> | . | STATUS | . | Connection | lost | · | ID | 1038745 |
| | . | | . | | | . | | |
| | . | | . | | | . | | |
| <time> | . | EXCEPTION | · | Connection | aborted | due | to | . . . |
| | . | | . | | | | | |
| | . | | . | | | | | |
| <time> | . | STATUS | . | Connection | lost | . | ID | 1456675 |
| | . | | . | | | . | | |
| | . | | . | | | . | | |
| <time> | . | STATUS | . | Connection | lost | . | ID | 1347829 |
| | . | | . | | | . | | |
| | . | | . | | | . | | |
| <time> | . | STATUS | . | Connection | lost | . | ID | 1783420 |
| | . | | . | | | . | | |
| | . | | . | | | . | | |

Executing Drain on the messages above, the log processor in one example gets the following result (with <*> representing a wildcard):

### Clusters:

1 (size 4): <time>: STATUS: Connection lost: ID<*>
2 (size 1): <time>: EXCEPTION: Connection aborted due to critical error: ID 1972384

As cluster 2 is more infrequent than cluster 1, cluster 2 is more likely to be flagged as an anomaly. Cluster 2 also includes keywords that may be fed into a machine learning algorithm that uses the keywords, such as “error keywords” (e.g., “exception”), as features in determining whether a message template is a notification-worthy anomaly.

A drain may use a fixed-depth or capped-depth tree. A fixed depth tree or capped depth tree is a tree where the “height” of the tree is limited. In the drain, this depth can be adjusted. Deeper trees may require additional resources to process but may produce more specific mappings. The number of children per node can be limited by a MaxChild parameter. Wider trees may require additional resources to process but may produce more specific mappings. The tree is made of the following levels:
The Root node does not encode any information and is only used to access the tree.
The first level encodes in the subtree the number of tokens that composes a log message.
The N next levels are used to encode the N beginning tokens. Drain assumes that beginning tokens are likely to be constant.
The leaf nodes have a collection of log groups (including tokens from the upper level nodes).

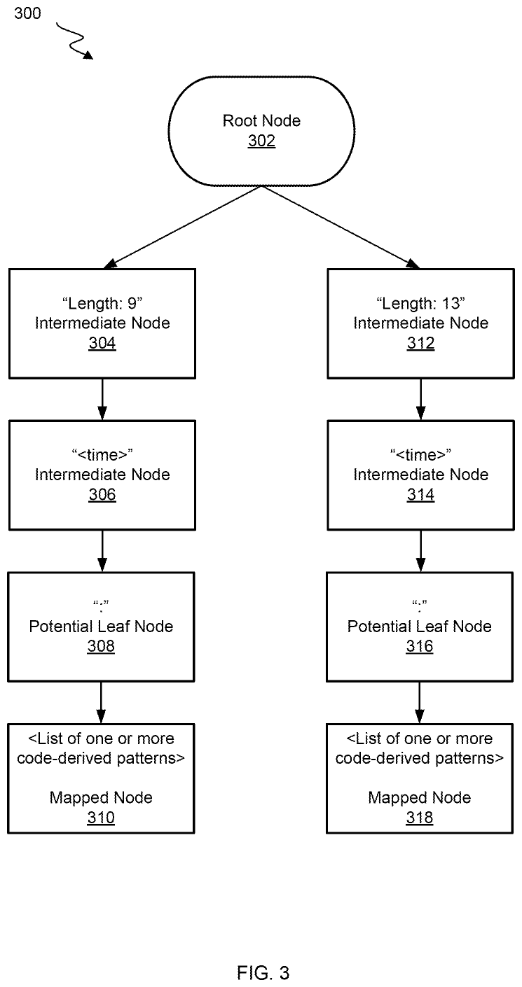

FIG. 3 illustrates a multi-level classification object 300, which may be implemented as a Drain or otherwise, for determining which one or more code-derived message patterns match an incoming message. The messages may be split into two messages paths, a first group of messages with length 9, as determined at intermediate node 304, and a second group of messages with length 13, as determined at intermediate node 312. The first intermediate nodes 306 and 314 in both groups are “<time>”, corresponding to the first token. The second nodes 308 and 316 in both groups, which are potential leaf nodes in the example, are “:”, corresponding to the second token. All other aspects of the first group are the same except Token 9, which is variant. In the example, the second group has only one message and so all aspects of the second group are unique to the one message with no detected variables.

According to the techniques described herein, tree structure 300 may be analyzed to determine if tree structure accounts for all code-derived patterns with enough specificity. If lists of one or more code-derived patterns in mapped nodes 310 or 318 mapped to potential leaf nodes 308 or 316 include too many code-derived patterns (such as more than 1, 2, 3, or 4 per leaf node), the tree may be modified to add new levels. For example, if there are still too many code-derived messages mapped to potential leaf node 308, a new node may be added below potential leaf node 308 to better distinguish between which code-derived messages any remaining log message patterns should be mapped.

After the tree is constructed or as the tree is being constructed but before the tree is fully constructed, the following message may be detected that would not fit into the tree as the message does not satisfy either group:
<time>: UPDATE: Connection status unknown: ID 1417858

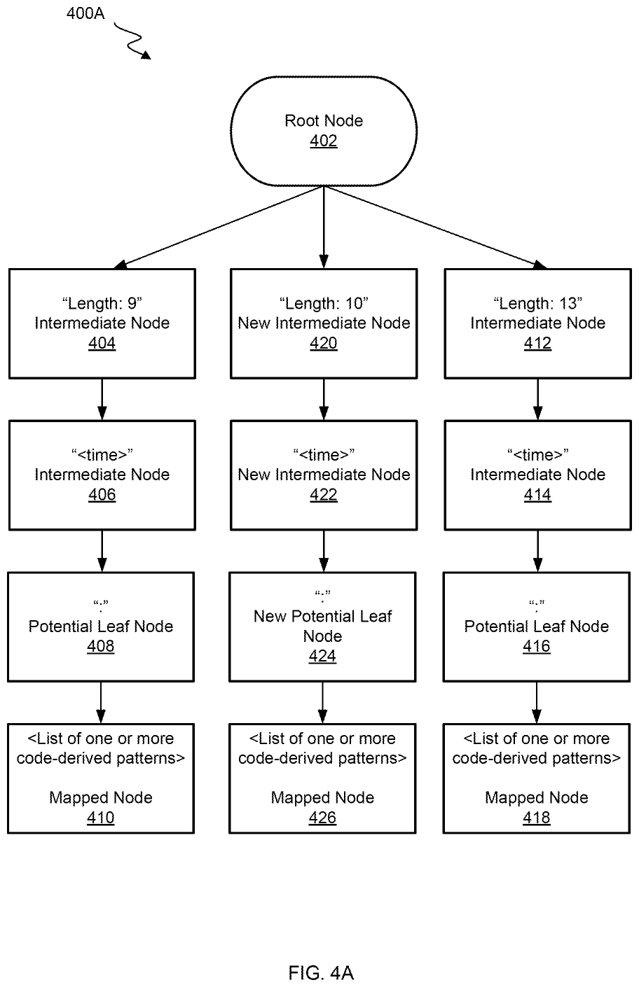

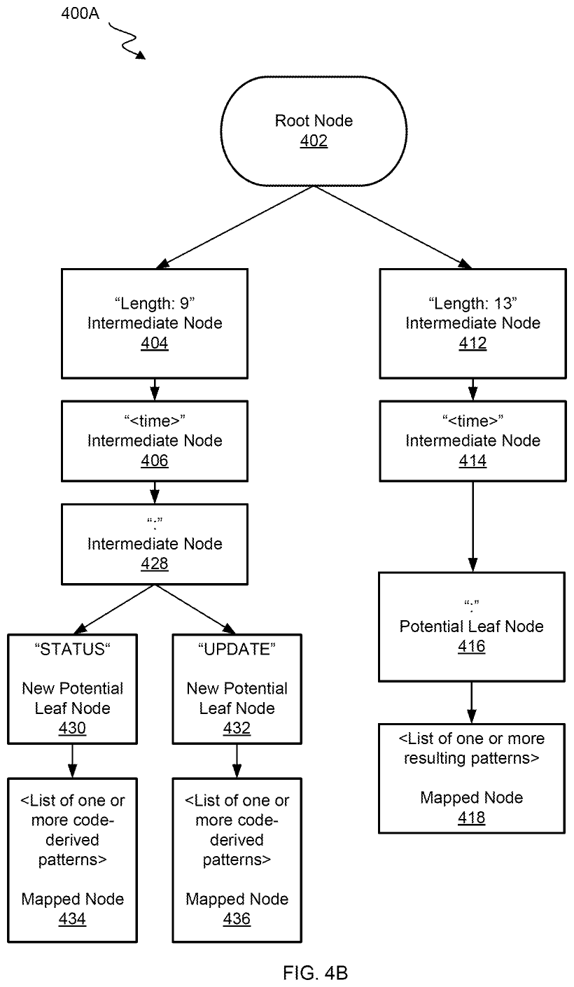

As there was no matching group and no path matching the first tokens, a new path and a new log group are created for the new message. FIG. 4A illustrates a multi-level classification object 400A that has been modified to determine more distinctly which one or more code-derived message patterns match an incoming message, by accounting for the new message. As shown in FIG. 4A, the multi-level classification object 400 has been modified to add new intermediate node 420 for “Length: 10”, new intermediate node 422 for “<time>” and new potential leaf node 424 mapped to a corresponding list of one or more code-derived patterns represented by mapped node 426. This new leaf node is able to classify the message above that did not previously fit in tree structure 300. In this example, the tree was made wider to accommodate the new pattern.

In another example, after the tree is constructed or as the tree is being constructed but before the tree is fully constructed, the following message may be detected that would fit into potential leaf node 308 but may cause mapped node 310 to refer to too many code-derived patterns.
<time>: UPDATE: Status unknown: ID 1417858

In this example, classification object 400B of FIG. 4B may be modified to split potential leaf node 308 into an intermediate node with a new level below, if there are too many code-derived message patterns in mapped node 310. Similarly, classification object 400B may also be modified to add new levels below node 416 if there are too many code-derived message patterns in mapped node 418. As shown, potential leaf node 308 is now intermediate node 428, which splits to new potential leaf node 430 or new potential leaf node 432, depending on whether the next token is “STATUS” or “UPDATE”. Each of these potential leaf nodes 430 and 432 may be mapped to corresponding mapped nodes 434 and 436, each with a list of one or more code-derived patterns. If the code-derived patterns are now below a threshold number of code-derived patterns per leaf node, the classification object 400B may be completed. The determination of how many code-derived messages lead to positively reinforced anomaly detection may be performed by a machine learning model using data about positive feedback received, and/or may be done using a lower-bound cutoff such as 1, 2, 3, or 4 code-derived message patterns per potential leaf node.

All other aspects of classification objects 400A and 400B, including root node 402, intermediate nodes 404, 412, 406, and 414, are similar to corresponding aspects 302, 304, 312, 306, and 314 of tree 300 of FIG. 3.

In order to find candidate groups for which to assign a new message, the log processor applies the group definitions from the root node down the tree to reach a leaf node. In the example, at the first level, the query processor selects the node matching the number of tokens of the log message. For every level after that, the tokens in the log message are used as keys. For instance, with the log <time>: STATUS: Connection lost: ID 1038745, the algorithm may search for the following nodes:
<time>→: for a Depth=2
<time>→:→STATUS for a Depth=3

The number of tokens in the tree depends on the depth and/or width. A deeper and/or wider tree improves performance but increases the risk that a token in the tree is actually a variable and artificially increases the processing time for handling the log message. For example, if a variable token leads to a tree with millions of nodes, the log processor may consume too many resources to perform the grouping operation for each log message.

If the algorithm found a candidate group, the message may be classified in the group. If not, a new group is created for the message, and a node may be added to the tree for the new group. Once a leaf node is reached, there is a list of candidate groups that might match the log message. If the tree depth is not high and the number of groups is high, a high remaining number of groups may be found on a single leaf. In our example, any log with an identical length and starting with <time>: would be on the same leaf.

To group logs together, Drain introduces a notion of distance called Token Similarity.

$$simSeq = \frac{{\sum }_{i = 1}^{n} e q u ( s e {q}_{1} ( i ) , s e {q}_{2} ( i ) )}{n}$$

where seq₁(i), seq₂(i) are two log messages (seq₁(i) being the i^{th} token), n the number of tokens and equ defined as:

$$e q u ( {t}_{1} , {t}_{2} ) = \{ \begin{matrix}1 if {t}_{1} = t - 2 \\ 0 else\end{matrix}$$

This can be applied on this log message made of n=5 tokens as follows.

| | | | | | |
|---|---|---|---|---|---|
| Representative | My | Awesome | Log | Is | <*> |
| Message | | | | | |
| Ingested | My | Error | Log | Is | Awesome |
| Message | | | | | |
| Sequence | 1/5 | 0 | 1/5 | 1/5 | 1/5 |
| Similarity | | | | | |
| Sequence | 1/5 | 1/5 | 2/5 | 3/5 | 4/5 |
| Similarity | | | | | |
| (Cumulative) | | | | | |

Which results in simSeq (Represenatitive Message, Ingested Message)=4/5

If the result of this function is higher than the similarity threshold st, the group is identified as the matching group. The algorithm may stop early if the cumulative sum has already reached the similarity threshold. If no group has been identified, a new group will be created.

When a group has been identified as a suitable log group, the drain will merge the log into the group. To do that, the log processor compares the log being ingested to the current representative of the group, token by token, and creates a new representative:
If the tokens are the same, the token is returned
Else, a wildcard is returned

For example, the merge of the following two logs:
<time>: STATUS: Connection lost: ID 1038745
<time>: STATUS: Connection lost: ID 1038745
will return:
<time>: STATUS: Connection lost: ID 1038745And the merge of the following two logs:
<time>: STATUS: Connection lost: ID 1038745<time>: STATUS: Connection lost: ID 1456675 will return:

<time>: STATUS: Connection lost: ID<*> In one embodiment, regardless of whether a drain is used to process the log messages, the log processor may start with anonymization of timestamps through the use of a placeholder (e.g., “<TIMESTAMPS>”), masking of logging levels using a placeholder (e.g., “<LOGLEVEL>”), and/or substitution of tokens containing numerical values with a placeholder (e.g., “<NUMWORD>”). This data preparation helps more accurately identify variant and invariant portions of the message.

In the same or another example, punctuation marks and/or superfluous delimiters are removed from the messages unless they provide valuable insights. These marks and delimiters often do not contribute to the contextual understanding of logs. Tokens or placeholders within the messages are preserved in order to prevent overfitting during the subsequent training process. The masking of irrelevant data is conducted in a manner that maintains the original order of token occurrence by using the mask tokens mentioned.

The type information determined for an incoming message may be used to narrow down which code-derived message text patterns are available for that type. Then, the log processor may perform a resource-constrained process to further determine which code-derived message text pattern matches the incoming message. In one example, by first narrowing down the code-derived message text patterns from 1,000,000 different patterns that can be generated by known libraries of source code to 100 different patterns that can be generated by a particular library of source code, the log processor may more quickly and efficiently, and with fewer levels of heuristics, rules, or analysis applied to smaller portions of the incoming log messages, determine which of the 100 different patterns match an incoming log message. In the example, by first filtering out 999,900 patterns that did not originate the message, the log processor does not need to spend time determining whether the incoming message matches any of the 999,900 patterns, some of which may be very close to the 100 patterns that are candidates for a match even after the filtering.

In one embodiment, a first-pass filter may differentiate log messages that contain different types of errors and anomalies, prompting review by different specialists, from each other. In other words, the first pass may narrow down the candidate code-derived message patterns to those that would be understood by an expert that regularly deals with a given type of message to troubleshoot a given subset of anomalies; whereas, other code-derived message patterns may be better understood by other experts who regularly deal with other types of messages to troubleshoot other subsets of anomalies.

The candidate code-derived message patterns remaining after the filtering (100 in the example) may have invariant portions that are different from each other. In other words, the 100 different versions of messages may have different skeletons within which variant portions are placed. Some of the 100 different versions may share common portions of skeletons that may cause further processing and analysis to distinguish between them. The incoming log messages may be processed in an N-pass fixed maximum complexity process per pass for sorting the incoming messages into the remaining candidate code-derived message pattern buckets that were determined in an initial pass.

In a first pass of substantive filtering based on contents of messages, the log processor may determine which portions of a message are most likely to be variant and which portions of a message are most likely to be invariant. For example, the log processor may determine the most likely portions to be invariant are the portions that are shared across many messages that have been processed in the past. These messages processed in the past may be used to construct a message classifying process or drain from which a portion of the message may be placed into a bucket of a fixed number of buckets that correspond to different message patterns, such that messages are designed to be able to fit into only one of the available buckets. For example, the drain may route the message into a fixed number of higher-level buckets based on whether a portion, such as a prefix, of the message contains certain content or keywords, matches a regular expression, or has other characteristics. The drain may then route the message into a lower-level bucket that further distinguishes parts of the message to discriminate between potentially multiple code-derived patterns that may still be mapped to the current level of the drain.

Without processing the entire message, the log processor may determine which bucket the portion of the message fits into and attempt to match the pattern indicated by the bucket to an available code-derived message pattern. If the bucket pattern has a one-to-one relationship with a code-derived message pattern, the log processor may determine that the received message matches the code-derived message pattern. If the bucket pattern is compatible with multiple code-derived message patterns, for example, because the bucket pattern is too high-level or covers only a small portion of an overall message, the log processor may re-perform the process with N passes with each pass having a fixed maximum complexity process such as a constant time algorithm. As a result, the log processor may identify the code-derived message patterns for log messages within a time-constrained and resource-constrained process, providing an improved ability to analyze the log messages and determine whether or not to treat the log messages as anomalous.

In one embodiment, a machine learning model is trained to match observed log message patterns with code-derived message patterns to a measured degree of confidence. Once incoming messages have been templatized or partially templatized into incoming message patterns, the machine learning model may compare the incoming message patterns to the code-derived message patterns in order to select, for each incoming message, a code-derived message pattern most likely to correspond with a pattern of the incoming message.

During the training phase, incoming messages are mapped to the source code that generated each message based on whether the code-derived message pattern from the source code matches or is compatible with a message pattern of the incoming message, using the associative property. If a message pattern matches multiple code-derived message patterns, the training process may progress to subsequent levels of clustering messages and matching to code-derived message patterns until a one-to-one mapping or some other matching accuracy condition between incoming message patterns and code-derived message patterns is satisfied.

Various examples are provided of more complex incoming message patterns that may be matched according to techniques described herein, and these are a small subset of the virtually unlimited number and variation of examples of log messages.
1. <TIMESTAMP> <NUMWORD> <LOGLEVEL> clssgmpDispatchWrkToWrkthrd src <NUMWORD> grock ASMCred <*> type <NUMWORD> msgtype <NUMWORD> thrdnum <NUMWORD>
2. <TIMESTAMP> <NUMWORD> <LOGLEVEL> clssgmDispatchCMXMSG: Queueing message type <NUMWORD> msg incarnation <NUMWORD> from node <NUMWORD> for later because queued msgs were found
3. <TIMESTAMP> <NUMWORD> <LOGLEVEL> clssgmSystemShutdown Received notification from proc that system shutdown was started
4. <TIMESTAMP> <NUMWORD> <LOGLEVEL> clssscagProcAgReq: Notifying agents that resource should remain down
5. <TIMESTAMP> <NUMWORD> <LOGLEVEL> clssscWaitChangeEventValue: ev unchanged from <NUMWORD>
6. <TIMESTAMP> <NUMWORD> <LOGLEVEL> Status for active hub node <NUMWORD> number <NUMWORD>
7. <TIMESTAMP> <NUMWORD> <LOGLEVEL> clssgmGroupAttrPrint: Attributes for group <*> <NUMWORD> <NUMWORD>

As can be seen in the examples above, static or non-variant portions of the messages are provided with the raw text or characters of the non-variant portions. As the incoming message templates are derived from actual messages, they may also include prefix information such as indicated by the placeholders <TIMESTAMP> <NUMWORD> <LOGLEVEL> to uniquely identify the log message from other log messages. More generally, the placeholders used in the actual message templates may be the same as the placeholders used for the code-derived message patterns, but in the example the placeholders are broader than the code-derived message patterns to facilitate an easier and quicker mapping between the incoming message and the incoming message pattern. The broader placeholders, such as “NUMWORD,” may be equivalent to several different message placeholder output types indicated in the code-derived message patterns, such as “% d” and “ou”. The invariant parts of the messages are combined with placeholders for the variant parts of the messages, indicated by <NUMWORD> (indicating any number) and <*> (indicating any text) in these examples, to form the code-derived message patterns. As shown in the examples, the placeholders distinguish between numbers and general text, but the placeholders may also be type-generic.

Multi-Level Matching with Capped Cost Adaptive Depth Classification

The incoming log messages may be processed in an N-pass fixed maximum complexity process per pass for sorting the incoming messages into the remaining candidate code-derived message pattern buckets or clusters that were determined in an initial pass. These buckets or clusters may be refined through multiple training phases based on information from or about the messages, from or about the matched code-derived message pattern clusters, or from feedback on past clustering performance. Larger clusters covering multiple code-derived message patterns may be further clustered into smaller clusters covering individual code-derived message patterns in a one-to-one mapping of cluster to code-derived message pattern, leading to more accurate and nuanced cluster formations and more precise anomaly detection but without wasting cycles processing messages into needlessly specific clusters that are more specific than the code-derived message patterns from which they are triggered. After N passes of clustering, bucketing, or categorizing the message, the log processor maps the message to an individual code-derived message pattern.

Generic templates are characterized by their association with multiple code-derived patterns, and may undergo a refinement process of additional passes of matching the incoming message patterns to the specific code-derived message pattern. In one example, this involves the creation of a refined drain model with adjusted parameters, including increased similarity thresholds and graph depth. The outcome is the development of finer templates or patterns through more accurate associations. After this additional training, the incoming message pattern to code-derived message pattern mappings may be recalculated. In one embodiment, the training process concludes once each message pattern is associated with fewer than a matching accuracy condition, M (e.g., 4), code-derived message patterns, or M portions of source code.

In a specific example, a message pattern initially detected by a drain portion might appear as: “<TIMESTAMP> <NUMWORD> <LOGLEVEL> Agent <*<*> <*> <NUMWORD>”, which may map to multiple different candidate code-derived message patterns, such as “Agent framework initialized, Process Id=% s” and “Agent framework offline, seconds to retry % s”, for example. After a pass at another drain portion, the multi-level drain may map the message to a message pattern: “<TIMESTAMP> <NUMWORD> <LOGLEVEL> Agent framework <*> Process <*><NUMWORD>”, which can then be mapped in a one-to-one mapping to the source code, “Agent framework initialized, Process Id=% s”.

In one embodiment, if, after N passes the log processor is still not able to determine with high confidence which code-derived message pattern matches the message, the log processor may mark the message as “unmatched” to trigger further processing in a pipeline that can tolerate more computationally expensive operations or to remain unmatched and unable to avail the benefits of a matched code-derived message pattern. In another embodiment, the drain is adjusted so that all code-derived message patterns can be determined in a 1:1 mapping from any given incoming message.

In one embodiment, if the machine learning model is unable to construct a drain that efficiently resolves a set of remaining message patterns to code-derived message patterns within a desired number of levels, the machine learning model may prompt a large language model or a user for a regular expression or keyword that divides a set of remaining messages or message patterns into two sets of relatively equal size (in terms of frequency of messages and/or number of matched code-derived message types); two regular expressions that divide a set of remaining message patterns into three sets of relatively equal size; or N regular expressions that divide a set of remaining message patterns into N+1 sets of relatively equal size. The regular expression may be used to exponentially narrow down the remaining messages to a single code-derived message pattern within the desired number of levels. In one embodiment, the regular expressions used for such a computation depend only on a portion of the messages and allow the log processor to perform the computations in constant time without parsing the entire log message.

The machine learning model may optimize a drain to handle patterns of high frequency with shallow drain levels, while patterns of lower frequency may be allowed to extend into deeper drain levels. Adding layers to parts of the drain may not greatly impact the overall expensive of processing log messages if the messages being categorized by such deeper parts of the drain are relatively infrequently occurring in the overall dataset. This is one example manner by which the machine learning model may balance efficiency and accuracy of matching incoming messages to code-derived message patterns for a large set of incoming messages.

As another example, the machine learning model may determine which part of the message to analyze at certain levels of the drain to improve processing efficiency and/or accuracy. If a set of incoming messages has a long prefix or other long but consistent section, for example, and the long prefix or other section is nearly the same for all messages in the set or all remaining messages to be analyzed at a particular level of the drain, starting analysis at the front of the prefix or other section may not lead to the most efficient results and may lead to deeper drain determinations on average. In this example, the machine learning model may determine, based on the frequency of messages received matching different patterns, that the greater filtering effect is obtained by starting N words into the message (e.g., to skip the prefix), from a specific point in the message (e.g., if other points prior to that point have already been analyzed or would not yield a significant filtering effect), after a particular section, from the end of the message, from a specific keyword or marker that is common to remaining messages, or based on a specific keyword or chunk of text that provides a good division between the remaining messages. Different levels of the drain may analyze different parts of the message depending on where the most efficiency can be obtained as determined by the machine learning model.

In one embodiment, at a particular level of a drain, the machine learning model determines a regular expression that divides the results into parts with a goal of equalizing or roughly equalizing the frequency of patterns occurring in each part, and/or the number of code-derived message patterns mapped to each part. The remaining parts may be used to resolve the drain to match an incoming message to a single code-derived message pattern at that particular level or at a lower level.

In one embodiment, different drains or otherwise different drain portions or levels of a drain may be used to process and categorize different portions of the incoming message, efficiently avoiding analysis of other portions of the incoming message. A drain portion may include any tree or sub-tree that is used to classify part of a message, and different trees or sub-trees may be used to classify an incoming message as a specific code-derived pattern. For example, a first drain portion or level may look at a first N (e.g., 3, 4, or 5) words of message patterns, a second drain portion or level may look at a next N words of message patterns, etc., to classify an incoming message as a code-derived message pattern. As the levels are traversed from top to bottom, or as the different trees are traversed, the number of candidate code-derived message patterns that may match the incoming message pattern may decrease until, at a leaf node, a number of matching code-derived message patterns satisfies a matching condition.

Other message classifiers may also be used that operate differently from drains. For example, a first message classifier component may receive, as input, a first portion of a message, and output a first set of candidate matching code-derived templates. A second message classifier component may receive, as input, a second portion of a message, and output a second set of candidate matching code-derived templates. A classifier may merge the first set and the second set to remove any non-overlapping candidate matching code-derived templates, if any, to result in a matched set of one or more code-derived templates. The classifiers may be trained to account for specific portions of the incoming messages, specific areas of variability of the incoming messages, and/or specific embeddings of the incoming messages as determined by a machine learning model to be relevant to narrowing down the incoming messages to resulting code-derived message patterns. For example, the specific embeddings may be determined to maximize variations, such as orthogonal degrees of variability, covered for the incoming messages such that a broad range of variations may be mapped to code-derived message patterns.

### Pattern Matching and Anomaly Detection Metrics

In the absence of labeled data for direct assessment and/or in addition to labeled data for direct assessment, the matching of incoming message patterns to code-derived message patterns evaluation relies on employing various statistical metrics to gauge the quality of clustering the messages into corresponding code-derived message patterns. These metrics leverage relative cluster information, comparing the characteristics of one cluster of message patterns to another. This comparison involves considering a first cluster of message patterns (designated as “A”), the logs associated with A, and contrasting them with a second cluster of message patterns (designated as “B”) and the corresponding logs for B.

The similarity and dissimilarity metrics described herein may be used to:
determine whether a cluster of incoming messages is similar to a code-derived message pattern, for evaluating a quality of the match between incoming messages and the code-derived message pattern,
determine whether a cluster of incoming messages or message patterns is similar to other clusters of incoming messages or message patterns, for evaluating whether a cluster of incoming message patterns is anomalous,
determine whether a code-derived message pattern or cluster of code-derived message patterns is similar to other code-derived message patterns or clusters of code-derived message patterns, for evaluating whether the code-derived message pattern is anomalous, and/or
determine whether any features of an incoming message, including the incoming message pattern, the code-derived message pattern, timing information, frequency information, and/or other metrics are similar to corresponding features of other incoming messages, for evaluating whether the incoming message is anomalous.

Several metrics may be utilized for cluster evaluation, each offering distinct insights into the effectiveness of the clustering. Examples of metrics include the Silhouette score, Calinski Harabasz score, Davies Bouldin score, Bayesian Information Criteria, and the variance within the clusters. Based on the score, the patterns or clusters may be reformulated or re-evaluated to produce more distinct clustering of the messages. The choice of an evaluation metric may be contingent upon the specific context and objectives of the clustering task. These metrics may furnish quantitative measurements that aid in evaluating cluster separation, compactness, and distinctiveness, thus facilitating the comparison and selection of the most appropriate hyperparameters.

The Silhouette score assesses the quality of clusters (such as those matching the same pattern) by measuring how similar a message is to the message's own cluster (cohesion) compared to other clusters (separation). The score ranges from −1 to 1. Higher values indicate well-separated clusters, while values near 0 indicate overlapping clusters. The Silhouette score for a single data point i=(b[i]−a[i])/max (a[i], b[i]), where:
a[i]: Average distance from point i to other points within the same cluster.
b[i]: Smallest average distance from point i to points in a different cluster.

The Calinski-Harabasz score or index, also known as the Variance Ratio Criterion, evaluates cluster quality based on the ratio of between-cluster variance to within-cluster variance. Higher values imply better-defined clusters. Calinski-Harabasz Index=(BSS/WSS)*(n−k)/(k−1), where:
BSS: Between-cluster Sum of Squares (measures variance between cluster centers).
WSS: Within-cluster Sum of Squares (measures variance within clusters).
n: Total number of data points.
k: Number of clusters.

The Davies-Bouldin score or index gauges cluster quality by considering both the average distance between each cluster's center and the cluster's points and the distance to the nearest cluster's center. Lower values indicate better clustering. Davies-Bouldin Index=(1/k)*Σ(max(Rᵢⱼ+Rⱼᵢ)) for all i≠j, where:
k: Number of clusters.
Rᵢⱼ: Average distance between cluster i's center and its points.
Rⱼᵢ: Distance between cluster i's center and cluster j's center.

The Bayesian Information Criterion (BIC) is a statistical criterion that balances the model's fit to data and complexity. Lower BIC values indicate a better model fit while considering the model's complexity. BIC=n*ln(RSS/n)+k*ln(n), where:
n: Number of data points.
RSS: Residual Sum of Squares.
k: Number of model parameters.

Variance measures how spread out a set of values is. In the context of clustering, variance indicates how data points are distributed around the cluster's center. Lower variance suggests more compact clusters. Formula (Population Variance): Variance=Σ(xᵢ−μ)²/N, where:
xᵢ: Each data point.
μ: Mean of all data points.
N: Total number of data points.

Different metrics may be chosen and may be appropriate in different scenarios. Although many metrics generate numerical scores, their interpretability must be considered so scores can be interpreted in a meaningful manner. Many metrics may demand computational resources at a level that is only available for smaller samples of datasets, used to train a model, and cannot be applied on larger datasets as messages are streaming into the system. Some evaluation metrics can be sensitive to outliers, noise, or minor fluctuations in data. This sensitivity can lead to less robust assessments, particularly when dealing with diverse data stemming from multiple hosts and nodes.

In one embodiment, labeled data is obtained for anomalies and/or clustering of messages to code-derived message patterns. A model can be trained on a known task (anomaly detection and/or clustering of messages to code-derived message patterns). This can improve the robustness of anomaly detection.

The machine learning model may be trained in a supervised, semi-supervised, or unsupervised manner. Using supervised learning, the machine learning model may rely on user feedback for code-derived message patterns that have been clustered together by categorizing incoming messages. The user may indicate, in various examples, that an incorrect code-derived message pattern was selected for an incoming message, and the machine learning model may accordingly lower a confidence score associated with the match that was made to the code-derived message pattern. This may cause the log processor to use a different incoming message pattern going forward at a level of the drain where the match was made, or to perform multiple iterations of determining incoming message patterns for portions of the incoming message and matching the patterns for the portions of the message to the code-derived message pattern, for example, by adding additional levels to the drain below the level where the match was made to the code-derived message pattern.

Using unsupervised learning, the machine learning model may rely on calculated distances between code-derived message patterns and incoming message patterns. The calculations may be made on a sample of data to ensure that these more intensive and computationally expensive calculations do not interfere with the log processor's ability to handle a high throughput of incoming log messages in the data pipeline. The machine learning model may sample matches that have been made and calculate overall character distances between the matched patterns to determine how different they actually are and whether the match was likely to be correct or not. A determination that the message patterns are more different than expected may trigger a decrease in the confidence score for that match between the incoming message pattern and the code-derived message pattern, possibly leading the machine learning model to trigger additional message analysis steps in the future before finally matching the message to the code-derived message pattern. For example, the machine learning model may add additional levels to a drain below the level where the match was made to the code-derived message pattern or may change the pattern that was used for a current level of the drain where the match was made.

In various embodiments, distances or other matching confidence scores between incoming message patterns and code-derived message patterns may be computed using TFIDF vectorization, cosine distance, and/or Levenshtein distance. During inference, the mappings generated in the training phase may be leveraged for improved accuracy.

Given the fixed-depth tree property of drain, in various examples, the inference process may be very fast. In one example, while training on 200 million log lines may take 10-12 hours, the inference on the same number of log lines may be completed in approximately 2 hours. Log files may be reactively analyzed, where anomalies can be detected within short time intervals. Log files may be classified into multiple components, such as CSS, CRS, EVM, etc., in an example involving clusterware architecture. This flexibility in file type classification allows for dedicated models for each component, significantly accelerating the inference process. The resource-intensivity of the unsupervised learning aspect may be incurred during training rather than inference, to promote efficient processing and analysis of incoming log files during inference.

In one embodiment, direct regular expression matching is used to match source code output to message patterns. Direct regular expression matching involves transforming source code by substituting string formatters with corresponding regular expression patterns, facilitating log message matching. Subsequently, log messages can be matched to the patterns, establishing incoming pattern to code-derived pattern associations through an associative property.

In the same or a different embodiment, Word2Vec and cosine similarity are used to match source code output to message patterns. Word2Vec is a word embedding technique in natural language processing (NLP) that transforms words into dense vectors, capturing semantic meaning and relationships. Word2Vec is based on the idea that words with similar contexts have similar vectors. This enables nuanced comparisons and arithmetic operations on words, enhancing various language tasks. Word2Vec has two main modes: continuous bag of words (CBOW) predicts a word from the word's context, while Skip-gram predicts context words from a given word. Other vector representations or embeddings of textual patterns can be generated instead of or in addition to Word2Vec, and the other embeddings may account for, for example, out-of-vocabulary words, and/or order or structure of words in the pattern.

When applying Word2Vec and cosine similarity to string matching, words may be converted in strings into their respective Word2Vec vectors, and then cosine similarity may be calculated between the vectors of two strings. The process combines Word2Vec with cosine similarity for string matching. Each word in strings is transformed into Word2Vec vectors. Cosine similarity is then calculated between these vector representations.

In a specific example, first, a word embedding is created by converting each word in the strings to the word's Word2Vec representation. Next, a string representation is created to represent each string as the sum or average of the string's word vectors. This gives a vector representation for each string. Then, cosine similarity is calculated between the vector representations of the two strings. Cosine similarity ranges from −1 to 1, with higher values indicating higher similarity. Matching is done between strings or patterns if the cosine similarity is above a certain threshold.

In one embodiment, code-derived patterns are matched with incoming message patterns using term frequency-inverse document frequency (TF-IDF) vectorization and cosine similarity. TF-IDF vectorization is a technique used in natural language processing to represent text documents as numerical vectors, capturing the importance of words within a corpus. TF-IDF aims to reflect how important a word is to a document or, in this case, a message or file, in relation to the entire corpus. TF-IDF takes into account both the frequency of a word in a document (TF) (or the frequency of a word in a message or of a message pattern in a file) and how rare the word is across the entire corpus (IDF) (or the frequency of the word in the file or of the word or message pattern in a set of files.

Term frequency (TF) measures how frequently a word or pattern appears in a specific document, or, in this case, a file or a set of files. TF is calculated by dividing the number of times a word occurs in a message by the total number of words in the message, or by dividing the number of times a message pattern occurs in a file by the total number of messages occurring in the file. The idea is that words that appear more often in a document, message, or file are likely to be more relevant to its content.

Inverse document frequency (IDF) measures how unique a word is across the entire corpus, or how unique a message pattern is across the entire corpus. IDF is calculated as the logarithm of the total number of documents or files divided by the number of documents or files containing the word or message pattern. Words or message patterns that appear in a limited number of documents are considered more significant as they can help distinguish between different documents.

The TF-IDF weight for a word in a message or a message in a file or corpus is the product of the word's TF and IDF scores. This weight quantifies how important a word is to the message or the message is to the file within the context of the entire corpus.
TF=(Number of occurrences of a word in a document)/(Total number of words in the document)
IDF=log ((Total number of documents)/(Number of documents containing the word))
TF-IDF=TF*IDF

TF-IDF captures document-level semantics by emphasizing words that are unique and important to a particular document. It's suitable for tasks that require distinguishing documents based on their content. In this case, TF-IDF can be used to distinguish message patterns based on their words, or to distinguish files based on their message patterns. Matching message patterns based on their words after vectorization may use cosine similarity on the vectors.

In one embodiment, the TF-IDF vector is enriched before performing cosine similarity by adding, to the vector, one or more metrics that quantify the order and structure of words in the incoming message patterns and/or the code-derived message patterns. This new metric would provide an additional foundation upon which to anchor the matching process, further refining the mapping between the message patterns.

As an alternative or addition to the approached described for matching message patterns, sequence-based matching may be used. This approach selects the best-matching string from a candidate list based on their similarity to an input string. Sequence based matching calculates the length of the Longest Common Subsequence (LCS) between the input and candidate strings. The similarity score is calculated as (2.0*LCS)/(len(s₁)+len(s₂)), considering LCS length and string lengths, for strings or message patterns s₁ and s₂.

In one embodiment, the actual distance between the incoming message pattern and one or more candidate code-derived message patterns may be determined using the Levenshtein distance algorithm. The Levenshtein distance algorithm compares two strings of text to determine how many character-by-character changes would be needed to transform one string of text into the other, in terms of deletions, insertions, or substitutions. A higher Levenshtein distance between the patterns would indicate that the patterns may not actually be compatible with each other; whereas, a Levenshtein distance of 0, once the placeholders have been given the same placeholder text in each of the patterns, means that the patterns are identical. The Levenshtein algorithm is not a constant time algorithm, as execution of the algorithm depends on the length of the messages and the degree of difference between the messages. The similarity ratio of the Levenshtein algorithm is calculated as:
sim=(total_characters−total_edit_operations)/total_characters*100, where
“total_characters” is the length of the longer string, and
“total_edit_operations” counts the edit operations needed to transform one string into the other. The resulting similarity ratio may range from 0 to 100, indicating the degree of similarity between the strings. A higher ratio signifies greater similarity.

In the same or a different embodiment, the distance between the incoming message pattern and one or more candidate code-derived message patterns may be determined using cosine similarity between vector embeddings of the patterns. The vectors may account for positioning of invariant portions, lengths of invariant portions, data types of variant portions, names of invariant portions, and other characteristics. The cosine similarity may be determined as the cosine of the angle between the two vectors, to determine how close the two vectors are to each other. The cosine similarity algorithm is not a constant time algorithm comparing messages, as vector embeddings of the incoming message patterns may depend on the length of the messages and/or the contents of the messages.

Using semi-supervised learning, the machine learning model may account for labeled data in terms of correct and/or incorrect matches between incoming log messages and code-derived message templates, as well as distances or other objective but computationally intensive metrics that are calculated on a sample of the matches that were made. The results from both the labels and the more computationally intensive calculations can be used to improve the machine learning model's prediction of which patterns to look for at which levels of processing, and how many levels of processing are needed to balance efficiency of processing with the accuracy of matches.

The cost of performing additional message analysis steps to achieve perfect matches is weighed against the cost of inexpensively matching incoming messages to code-derived message templates. The machine learning model may tolerate a level of inaccuracy in order to maintain an efficient and simple process for determining patterns of incoming messages and matching those patterns to code-derived message patterns. The machine learning model may also manage an overall expected cost of processing log messages in order to maintain the overall expected cost to be below a threshold level per log message. This ensures that the machine learning model and log processor can keep up with the incoming pipeline of messages to analyze.

In one embodiment, an LLM may serve as a high-level feature extractor for complex log structures like core dumps, SQL dumps, stack traces, and HEX dumps, to extract individual characteristic information from logs beyond how frequently the patterns occur. Features derived for messages may be used to label message patterns to which the messages belong, and/or features derived for patterns may be used to label messages that belong to the patterns. A machine learning model may consume the features to determine an anomaly score for an incoming messages or set of incoming messages based on whether the features have been associated with anomalies in the past or otherwise labeled anomalous.

In one embodiment, messages and/or message patterns may be labeled using a large language model to understand contents of the messages and/or message patterns. For example, a set of messages may include a core dump that spans multiple messages. A set of messages may be included in a prompt to a large language model, in the example below.

### Prompt

These are a few samples of dump log lines:
2022 Dec. 1 19:42:53.880: SKGFD: 2485249792: 0x0x7fdb94210e50 98 b2 41 00 00 00 00 00-00 00 00 00 00 00 00 00_A_
2022 Dec. 1 19:42:53.880: SKGFD: 2485249792: 0x0x7fdb94210e60 4f 52 43 4c 44 49 53 4b-00 00 00 00 00 00 00 00ORCLDISK_
2022 Dec. 1 19:42:53.880: SKGFD: 2485249792: 0x0x7fdb94210e70 00 00 00 00 00 00 00 00-00 00 00 00 00 00 00 00_
2022 Dec. 1 19:42:53.880: SKGFD: 2485249792: 0x0x7fdb94210e80 00 00 00 13 06 00 03 03-44 41 54 41 43 31 5f 43_DATAC1_C

Extract dump log lines from the below text and list it in json format with attribute dumpLines:
2022 Dec. 1 19:42:53.881: CLSF2485249792: 0: expected 1 actual 1
2022 Dec. 1 19:42:53.881: CLSF2485249792: 1: expected 150 actual 150
2022 Dec. 1 19:42:53.881: CLSF2485249792: 2: expected 1 actual 2
2022 Dec. 1 19:42:53.881: CLSF2485249792: 3: expected 0 actual 0
2022 Dec. 1 19:42:53.881: CLSF2485249792: 4: expected 0 actual 0
2022 Dec. 1 19:42:53.881: CLSF2485249792: 5 expected 1 actual 1
2022 Dec. 1 19:42:53.881: CLSF2485249792: 6 expected 3855411207 actual 851049213
2022 Dec. 1 19:42:53.881: CLSF2485249792: bh: ptr 0x7fdb94210e40 size 512
2022 Dec. 1 19:42:53.881: SKGFD: 2485249792: bh: dump of 0x0x7fdb942f0e40, len 512
2022 Dec. 1 19:42:53.881: SKGFD: 2485249792: 0x0x7fdb94210e40 01 82 01 02 00 00 00 00-0a 00 00 80 fd fa b9 32_2
2022 Dec. 1 19:42:53.881: SKGFD: 2485249792: 0x0x7fdb94210e50 98 b2 41 00 00 00 00 00-00 00 00 00 00 00 00 00_A_
2022 Dec. 1 19:42:53.881: SKGFD: 2485249792: 0x0x7fdb94210e60 4f 52 43 4c 44 49 53 4b-00 00 00 00 00 00 00 00 ORCLDISK_
2022 Dec. 1 19:42:53.881: SKGFD: 2485249792: 0x0x7fdb94210e70 00 00 00 00 00 00 00 00-00 00 00 00 00 00 00 00_
2022 Dec. 1 19:42:53.881: SKGFD: 2485249792: 0x0x7fdb94210e80 00 00 00 13 0a 00 03 03-44 41 54 41 43 31 5f 43_DATAC1_C
2022 Dec. 1 19:42:53.881: SKGFD: 2485249792: 0x0x7fdb94210e90 44 5f 30 35 5f 46 52 41-31 30 34 32 30 37 45 58 D_05_FRA104207EX

### Response

```
[
“dumpLines”:[
    “SKGFD:2485249792: bh: dump of 0x0x7fdb942f0e40, len 512”
    “SKGFD:2485249792: 0x0x7fdb94210e40 01 82 01 02 00 00 00 00 −
0a 00 00 80 fd fa b9 32_____2”,
    “SKGFD:2485249792: 0x0x7fdb94210e50 98 b2 41 00 00 00 00 00 −
00 00 00 00 00 00 00 00 _A_____”,
    “SKGFD:2485249792: 0x0x7fdb94210e60 4f 52 43 4c 44 49 53 4b −
00 00 00 00 00 00 00 00 ORCLDISK____”,
    “SKGFD:2485249792: 0x0x7fdb94210e70 00 00 00 00 00 00 00 00 −
00 00 00 00 00 00 00 00______”,
    “SKGFD:2485249792: 0x0x7fdb94210e80 00 00 00 13 0a 00 03 03 −
44 41 54 41 43 31 5f 43_____DATAC1_C”,
    “SKGFD:2485249792: 0x0x7fdb94210e90 44 5f 30 35 5f 46 52 41 −
31 30 34 32 30 37 45 58 D_05_FRA104207EX”
  ]
]
```

In the example, a set of received messages is identified as collectively representing a core dump and may be labeled accordingly. The LLM may be used to generate additional labels and other characteristics of the received messages. Based on these additional features, the received messages may be mapped to a code-derived message pattern that is known to output several messages that make up a core dump. The code-derived message pattern may also be labeled with “core dump” or another label to facilitate matching on specific complex message patterns. As described above, the label on the code-derived message pattern may also be obtained from an LLM, or as a manually provided label. In the example, because the messages received and the code-derived message pattern have the same label or marked characteristics or other features, the patterns may be matched together even though the message contents are otherwise highly unstructured compared to many other message patterns.

Detecting Anomalies from Incoming Log Messages

Referring back to FIG. 1, after the particular message has been matched to a particular code-derived message pattern in block 106, process 100 continues to block 108, where a determination is made on whether the particular message is a notification-worthy anomaly based on the particular code-derived message pattern. If the particular message is determined to be a notification-worthy anomaly, process 100 continues to block 110, where a notification or other action is triggered responsive to the anomaly. A notification-worthy anomaly is an anomaly for which the machine learning model, statistics or metrics, and/or user feedback have indicated a notification should be sent about the anomaly. Examples, which may vary system to system, tenant to tenant, and/or user to user, include errors, timeouts, messages about delays, memory exceptions, unusually high workloads, unusually low available resources, etc.

Once a notification has been sent, process 100 continues to block 112, where metadata is stored indicating that the message was marked as a notification-worthy anomaly. If the particular message is not determined to be a notification-worthy anomaly, processing continues directly to block 112, where metadata is stored indicating that the message was not marked as a notification-worthy anomaly. Examples, which may vary system to system, tenant to tenant, and/or user to user, include a message that a user session has timed out, a message that a query was improperly constructed and could not be executed, a message about routine but rare maintenance, etc.

Referring back to FIG. 2, the log processor subsystem 216 uses pattern matching model 208 to match incoming log message patterns to code-derived message patterns, resulting in code-derived message pattern 218 for log message 204. Anomaly detection subsystem ingests information about code-derived message pattern 218 and uses anomaly detection model 222 to classify log message 204 as a notification-worthy anomaly or not. Anomaly detection model 222 may account for unsupervised statistical data or other metrics that were used to generate pattern matching model 208 or otherwise determined from analytical processing on a sample (e.g., a strict subset that is less than the full set) of source code portions and/or log messages. Anomaly detection model 222 may also account for supervised data in the form of feedback 232 or other labels from expert users, via expert user system(s) 230. In the example shown, feedback 232 is provided after anomaly detection subsystem 220 determines whether the message is a notification-worthy anomaly 226 or recorded as a non-anomalous message 228. An expert user via expert user system 230 may review the classification for various log files and provide feedback 232 if the classifications as notification-worthy anomalies 226 or non-anomalous messages 228 are correct or incorrect. Anomaly detection model may combine these unsupervised metrics and supervised labels in order to improve anomaly detection using code-derived message patterns.

In various embodiments, the incoming log messages themselves may be used to detect anomalies. The messages may be reduced to patterns of messages by marking common message content in common locations for the message content as invariant text and uncommon message content as variable text across a wide range of messages. Messages with the same or similar invariant text in the same or similar locations within the messages may be clustered together as having a same or overlapping message pattern. As new messages come in, messages may be routed to an existing message pattern based on whether portions of the message content match corresponding portions of existing message patterns. New message patterns may be created for messages that do not match any existing message patterns.

Messages may be labeled by the log processor based on the message patterns the messages match. In one embodiment, the log processor organizes the messages so that messages having the same patterns are stored together and are available to be retrieved together for further analysis. Messages may be streamed into storage according to settings of the system manager when the message sources were registered, and stored or grouped based on when the messages were received, based on the pattern matched, based on the source the message came from, or based on any other characteristic of the message, whether detected by parsing and/or categorizing the message or based on how the message was received or where the message was received from.

In one embodiment, a machine learning model uses a combination of diverse similarity metrics and detection metrics to identify potential anomalies, including, for example, any of the metrics in the previous section. Various similarity metrics may establish the resemblance between different elements, such as similarities or differences between different clusters or patterns of messages, and/or similarities or differences between individual messages having the same cluster or pattern. For example, similarity may be determined based on cosine similarity, L2 distance (Euclidean distance), and L1 distance (Manhattan distance) to measure the likeness between different data points. The machine learning model may also account for different detection metrics, which encompass z-score, standard deviation (std), Median Absolute Deviation (MAD), and median, to determine the degree of deviation from established norms. Any one or more of these metrics may be used to detect anomalous message patterns or clusters and also to detect whether an incoming message fits well within or is similar enough to an existing pattern or cluster.

Cosine similarity measures the cosine of the angle between two vectors. Cosine similarity is used to determine the similarity between documents or data points in high-dimensional spaces. The range is from −1 (completely dissimilar) to 1 (completely similar). Cosine Similarity=(A·B)/(∥A∥*∥B∥), where: A and B are the two vectors being compared, “·” denotes the dot product of the two vectors, and ∥A∥ and ∥B∥ are the magnitudes (lengths) of the vectors. Cosine similarity may be used to evaluate the match of an individual message to a cluster, to determine whether messages do not fit well within existing clusters, and/or to determine how different a cluster or pattern is from other clusters or patterns.

In one embodiment, a similarity score may be determined between a cluster or pattern of messages and other clusters or patterns of messages, or between an individual message that matches a cluster or pattern and other messages that match the cluster or pattern. Subsequently, these values may be evaluated to determine their respective z-scores. If the z-score of a value exceeds a predefined threshold, the corresponding value is marked as an anomaly or more likely to be a notification-worthy anomaly. The z-score standardizes a data point by expressing how many standard deviations the data point is away from the mean. The z-score helps identify outliers and measure the significance of a value within a dataset. Z-Score=(x−μ)/σ, where:
x is the data point.
μ is the mean of the dataset.
σ is the standard deviation of the dataset.

Standard deviation measures the spread or dispersion of a dataset. Standard deviation indicates how much individual data points deviate from the mean. Messages deviating from a matched pattern's mean, or a pattern deviating from other patterns' mean, may indicate an anomaly. Std=√(Σ(xᵢ−μ)²/N), where:
xᵢ is each data point.
μ is the mean of the dataset.
N is the total number of data points.

Median Absolute Deviation (MAD) quantifies the dispersion of data points around the median. MAD is a robust alternative to standard deviation, less influenced by outliers. Messages deviating from a matched pattern's mean, or a pattern deviating from other patterns' mean, may indicate an anomaly. MAD=median (|xᵢ−median(x)|), where:
xᵢ is each data point.
median(x) is the median of the dataset.

There are some message patterns that should be treated more likely as errors regardless of individual scores, such as the message pattern: “Database failure, ORA-00600 error due to {ERROR}”. Additional labels or information may be obtained to flag certain patterns as likely anomalous, and multiple features or aspects of information about the message and/or the code-derived message pattern mapped to the message may be used to detect anomalies that are not detected from single feature evaluations. Incorporating human feedback and conducting feature-level analyses could enhance the efficacy of anomaly detection in complex, non-normally distributed datasets. This feedback can be incorporated into a machine learning model in the training phase.

Because many log messages may be generated during the process of completing one task or one item of product or service functionality, and/or because many tasks are being completed by the system using limited resources, the process of consuming and processing log messages is often highly resource constrained with a large pipe of data feeding into a relatively lightweight process in terms of computing time consumed per log message. If too much computing time is consumed per log message, the log processor would not be able to keep up with the large pipe of data feeding into the log processor. This would result in data that is processed more heavily but always stale and lagging significantly behind the received streams of data. Stale data may be useful for data warehousing and after-the-fact in-depth analyses, but stale data is not as helpful for on-the-fly real-time or near-real-time anomaly detection.

Due to this resource constraint, labeling and categorizing processes usually result in high-level categories of log messages with little analysis applied beyond this initial label or category. Without knowledge of how the log messages were created, the categories may be artificially split based on frequently occurring message content that is actually variable but appears invariant since particular variable values occur so frequently. For example, if a variable value occurs frequently in a dataset of streaming log messages, the frequently occurring variable value may be detected as accounting for a cluster of data. Less frequently occurring variable values for a log message that is otherwise the same may be classified as belonging to a separate cluster even though the message may communicate substantially the same information.

The categories may also be artificially combined based on messages that appear identical or nearly identical but originate from different sources or in other scenarios where similar messages have a substantially different meaning. For example, one log message may report an attempt to access a locked resource followed by the resource's size, in bytes (e.g., “Table Locked-EMP_SALARY-300000”; and another log message may report an attempt to access a locked resource followed by the amount of time spent waiting in milliseconds (e.g., “Table Locked—EMP_SALARY—300000”). The log messages may originate from two different places in code and have two different meanings. Even if the log messages are not identical, high degrees of similarity may cause the log messages to be clustered together and analyzed together. While a table size of 300,000 bytes, or 300 Kb, might not give rise for concern, a wait time of 300000 milliseconds (300 seconds, or 6 minutes) or even lower may give rise for concern if properly understood and processed. As there is no practical way to analyze each message individually in depth, the approach of categorizing incoming log messages based on their content alone and without additional background information may miss this message of significant concern.

In one embodiment, matching messages received with code-derived message text patterns helps the log processor determine which portions of code most commonly generate messages. For portions of code known to generate error messages, which indicate anomalies, matching the messages received with code-derived message text patterns helps the log processor determine which portions of code most commonly generate error messages which indicate anomalies. These common paths of failure may be more detectable, and a system administrator or analyst may be more quickly notified of these common paths of failure occurring, if an incoming message is known to originate from one of the common paths.

Even for code not known to generate error messages, matching the messages received with code-derived message text patterns helps the log processor determine which portions of code rarely or anomalously generate messages, and detecting messages from those portions of code may indicate that an anomaly is occurring or has occurred. These anomalies may be indicated in a notification to the system administrator or analyst for further investigation, or may be linked to other anomalies that are also occurring in a root cause analysis of an anomalous event that is the subject of a notification to the user.

In one embodiment, during an auto-marking phase, the system manager derives frequency statistics for each code-derived message pattern, along with the confidence scores resulting from mappings between candidate message patterns and the code-derived message patterns. In addition to distances between code-derived message patterns and candidate message patterns, several example metrics may also be determined:
1. Total Frequency: The cumulative instances of a code-derived message pattern appearing across all files.
2. File Count: The number of files in which a code-derived message pattern is present.
3. Average Frequency: Obtained by dividing the total frequency by the file count.
4. Occurrence Ratio: Derived by dividing the file count by the total number of files evaluated.

These metrics may be calculated independently using both incoming message patterns and code-derived message patterns as bases. The average frequency and occurrence ratio may be used for automated anomaly classification. In a particular example, the classification process includes segregating all code-derived message templates into four quartiles based on these metrics. The resultant observations (not final markings) on anomalies based on these features are as follows:

| Occurrence Ratio | Average Frequency | Observation |
|---|---|---|
| High (>0.01) | High (>5) | Unlikely To Be Anomaly |
| Low (<0.01) | High (>5) | Subject to “Expert |
| | | Supervision” |
| High (>0.01) | Low (<5) | Subject to “Expert |
| | | Supervision” |
| Low (<0.01) | Low (<5) | Possible Anomaly |

In one embodiment, the machine learning model uses a quartile-based classification based on one or more features determined from the incoming message pattern, the code-derived message pattern, the incoming message itself, and/or the code generating the code-derived message patterns. Specific example metrics include, but are not limited to, average frequency of a message pattern or code-derived message pattern in a file or set of messages, occurrence ratio of a message pattern or code-derived message pattern in a file or set of messages, and/or occurrence ratio of a message pattern in a service request. In one embodiment, a truth table may be constructed based on thresholds on average frequency and occurrence ratio per file like below.

TABLE 2
Truth Table Use For Determining Match Scores

| | | | | | Ave | | | |
|---|---|---|---|---|---|---|---|---|
| | | Incoming | | | Frq | | | |
| | Code-Derived | Message | Cos | Lev | Per | Occ | | |
| # | Message Pattern | Pattern | Sim | Dis | File | Ratio | A | Rnk |
| 1 | clssgmpDispatchWrkTo | <TIMESTAMP> | 0.92 | 94 | 4.75 | 0.002 | T | L-L |
| | Wrkthrd: src % d grock | <NUMWORD> | | | | | | |
| | % s, type % d, msgtype | <LOGLEVEL> | | | | | | |
| | % d, thrdnum % d | clssgmpDispatchWrkToWrkt | | | | | | |
| | | hrd src <NUMWORD> grock | | | | | | |
| | | ASMCred <*> type | | | | | | |
| | | <NUMWORD> msgtype | | | | | | |
| | | <NUMWORD> thrdnum | | | | | | |
| | | <NUMWORD> | | | | | | |
| 2 | clssgmDispatchCMXMSG: | <TIMESTAMP> | 1 | 100 | 3.57 | 0.004 | T | L-L |
| | Queueing message type % d | <NUMWORD> | | | | | | |
| | msg incarnation % u from | <LOGLEVEL> | | | | | | |
| | node % d for later because | clssgmDispatchCMXMSG: | | | | | | |
| | queued msgs were found | Queueing message type | | | | | | |
| | | <NUMWORD> msg | | | | | | |
| | | incarnation <NUMWORD> | | | | | | |
| | | from node <NODWORD> | | | | | | |
| | | for later because queued msgs | | | | | | |
| | | were found | | | | | | |
| 3 | clssgmSystemShutdown: | <TIMESTAMP> | 1.00 | 100 | 1.47 | 0.235 | P | L-H |
| | Received notification | <NUMWORD> | | | | | | |
| | from proc(% p) that system | <LOGLEVEL> | | | | | | |
| | shutdown was started | clssgmSystemShutdown | | | | | | |
| | | Received notification from | | | | | | |
| | | proc that system shutdown | | | | | | |
| | | was started | | | | | | |
| 4 | clssscagProcAgReq: | <TIMESTAMP> | 1.0 | 100 | 1 | 0.245 | P | L-H |
| | Notifying agents that | <NUMWORD> | | | | | | |
| | resource should remain | <LOGLEVEL> | | | | | | |
| | down | clssscagProcAgReq: | | | | | | |
| | | Notifying agents that resource | | | | | | |
| | | should remain down | | | | | | |
| 5 | classicWaitChangeEvent- | <TIMESTAMP> | 1 | 100 | 100.9 | 0.009 | P | H-L |
| | Value: ev(% s) | <NUMWORD> | | | | | | |
| | unchanged from % u | <LOGLEVEL> | | | | | | |
| | | clssscWaitChangeEventValue: | | | | | | |
| | | ev unchanged from | | | | | | |
| | | <NUMWORD> | | | | | | |
| 6 | Status for active % s, | <TIMESTAMP> | 0.82 | 81 | 19.4 | 0.019 | P | H-L |
| | node % s, number % u: | <NUMWORD> | | | | | | |
| | hub rim | <LOGLEVEL> Status for | | | | | | |
| | | active hub node | | | | | | |
| | | <NUMWORD> number | | | | | | |
| | | <NUMWORD> | | | | | | |
| 7 | clssgmGroupAttrPrint: | <TIMESTAMP> | 1 | 100 | 1556.2 | 0.443 | F | H-H |
| | Attributes for group % s, | <NUMWORD> | | | | | | |
| | ID % u:% u | <LOGLEVEL> | | | | | | |
| | | clssgmGroupAttrPrint: | | | | | | |
| | | Attributes for group <*> | | | | | | |
| | | <NUMWORD> | | | | | | |
| | | <NUMWORD> | | | | | | |

Table 2 shows some example patterns and their frequency statistics with anomaly markings. From left to right, the columns show signature or message pattern number (#), code-derived message pattern, incoming message pattern, cosine similarity (Cos Sim), Levenshtein distance (Lev Dis), average frequency per file (Ave Frq Per File), occurrence ratio (Occ Ratio), anomalous flag (A), and rank (Rnk). In the example, the code-derived message pattern shows a pattern of message output determined based on portion(s) of code that contribute to outputting the corresponding message. The incoming message pattern shows the pattern determined as a result of a fixed-depth-per-pass classification of the message. The cosine similarity shows the cosine of the angle between the embedding vector of the code-derived message pattern and the embedding vector of the incoming message pattern. The Levenshtein distance shows the number of characters that differ between the code-derived message pattern and the incoming message pattern. The average frequency per file shows the average number of times the message pattern is detected in a file or set of messages. The occurrence ratio shows how frequently the message pattern occurs compared to other message patterns in service requests, which may be represented as unique files.

The anomaly marking shows whether the message pattern should be treated as an anomaly or whether the machine learning model should determine whether the message pattern is an anomaly, with “T” indicating “True” or yes, treat as an anomaly; “F” indicating “False” or no, do not treat as an anomaly; and “P” indicating “Possible,” let the other features used by the machine learning model guide the decision. The rank shows the quartile of the average frequency per file and the quartile of the occurrence ratio to signal to the machine learning model whether the message pattern be treated as an anomaly, with H indicating “High” and “L” indicating “Low.” An L-L rating indicates that both the average frequency per file and occurrence ratio are low, which indicates a message matching the message pattern is likely anomalous (“T” for “True”) potentially depending on other factors. An H-L rating indicates that the message pattern occurs frequently per file but infrequently per service request, indicating that a message matching the message pattern might be anomalous depending on other factors (“P” for “Possible”). An L-H rating indicates that the message pattern occurs infrequently per file but frequently per service request, indicating that a message matching the message pattern might be anomalous depending on other factors (“P” for “Possible”). An H-H rating indicates that the message pattern occurs frequently per file and frequently per service request, indicating that a message matching the message pattern is likely not anomalous, potentially depending on other factors (“F” for “False”). In one embodiment, additional feedback or expert-guided labels are requested and provided for patterns having a “Possible” anomaly marking.

A resulting one-to-one mapping between incoming message patterns and code-derived messages may provide additional details, including the code file name, code file path, and code function name from which the log line originated. This additional information accelerates the diagnosis of anomalies in addition to helping detect the anomalies.

In one embodiment, the system manager uses Language Model-based feature extraction, referred to as LLMs (Large Language Model), to parse and distill valuable insights from these heterogeneous log messages as to whether the log entry may relate to an anomaly or not, including using large language models in accordance with the techniques described in the previous section. The system manager may prompt one or more LLMs with information about the log message to extract a variety of additional features such as Resource Allocation, Anomaly Duration, Unusual Dependencies, Query Complexity, Sentiment Analysis, and Error Code Analysis from the log data. These additional features may be weighed by a machine learning model in determining whether a message is a notification-worthy anomaly or a non-notification-worthy message.

The machine learning model may combine the additional features with the frequency statistics and employ a classifier to autonomously detect anomalies within the system. To further improve the accuracy of these markings, a human-in-the-loop correction mechanism may be employed. Experts review and refine the flagged anomalies, ensuring that the final assessment is both accurate and reliable. This combination of automated analysis and human expertise forms a robust anomaly detection workflow, allowing for the efficient identification and resolution of critical system issues.

For instance, an incoming message pattern generated by the multi-level drain might be: “<TIMESTAMP> <NUMWORD> <LOGLEVEL> Agent framework <*> Process <*> <NUMWORD>”. Correspondingly, the associated source code could generate a message having the code-derived message pattern of: “Agent framework initialized, Process Id=% s,” with details such as code file path, code file name (clsAgfwInterface.cpp), function name (clsAgfwInit2), and line number (592). Once the incoming message pattern is matched to the code-derived message pattern, this additional information may be used to facilitate anomaly detection, and/or any portions or combinations of this additional information may be provided in a notification that the anomaly has been detected, to facilitate efficient review of the notification.

In one embodiment, the log processor stores information about different types of messages received over time, and the system manager uses this information to determine super-patterns of multiple messages that are anomalous and super-patterns of multiple messages that are not anomalous. For example, messages of different types may be received over time with none of the particular messages occurring so infrequently as to indicate an anomaly. However, the messages may normally occur in a consistent or frequently occurring super-pattern where a message from a specific code-derived message text pattern A′ of type A (such as CSS) is received before a specific code-derived message text pattern B′ of type B (such as CRS), which is received before a specific code-derived message text pattern C′ of type C (such as CRF). If A′, B′, and C′ always or almost always appear in this order, the system manager may detect an anomaly when a message matching A′ is followed by a message matching C′ without a message matching B′.

Anomalies may be linked between different types of messages in known signatures of anomalies. In the example above, a known anomalous signature may be stored as “A′-NOT B′-C′” to indicate an anomalous signature exists when A′ is followed by C′ without an intervening B′ message. Similarly, non-anomalous signatures may be stored for frequent patterns. In the example above, a non-anomalous signature may be stored as “A′-B′-C′” to indicate that A′ messages are frequently followed by B′ messages and then C′ messages.

In one embodiment, a machine learning model is trained to detect anomalies based on frequencies of occurrences of patterns in incoming messages, frequencies of occurrences of code-derived message patterns matched to incoming messages, labels of source code or types that originated code-derived message patterns matched to incoming messages, labels of specific patterns within the patterns of incoming messages or code-derived patterns matched to incoming messages, labeled data that rises to the level of triggering action, such as a notification, labeled data that does not rise to the level of triggering action, feedback on past notifications or actions, labels of super-patterns that rise to the level of triggering action, labels of super-patterns that do not rise to the level of triggering action, topology information that connects messages and sources together in a system being monitored, values of variables in placeholder locations in the received messages, value distributions of the variables, and value-based anomalies, weights of variables in placeholder locations of the received messages, thresholds placed on certain values, anomalous regions of values, non-anomalous or normal regions of values, and any other information that is helpful to determine whether action should be taken with respect to an anomaly conveyed by information contained in one or more received messages. This information may be combined and weighted, and the weights adjusted of different parameters adjusted, in a hyperparameter tuning process as the model is trained to better detect action-worthy anomalies.

The machine learning model for categorizing messages as action-worthy anomalies may be trained on separate types, such as CSS, CRS, or CRF within the clusterware. The separate types may prompt different decisions on whether different messages are notification-worthy anomalies or not, and what other factors to take into account in making a recommendation on whether different messages are notification-worthy anomalies or not. In another embodiment, the same machine learning model is used for all types of messages, with different specific patterns or types of messages being tuned differently to account for different parameters or features using different weights.

The machine learning model for categorizing messages as action-worthy anomalies may include a feedback loop. Once a user is notified of an anomaly, the user may provide feedback via the notification to the system manager. The feedback may indicate whether the notification of the anomaly was viewed positively or negatively by the user. If the notification of the anomaly was viewed negatively, similar anomalies may be more likely to be suppressed without notifications in the future. If the notification of the anomaly was viewed positively, similar anomalies may be more likely to be exposed with notifications.

In one embodiment, the machine learning model for categorizing messages as action-worthy anomalies or non-action-worthy messages receives feedback and is trained on specific to individual users or groups of users. Feedback from an individual user or group of users may be consumed to adjust hyperparameters and tune the model in use to classify action-worthy anomalies for that user or group of users. A message or set of messages of a particular pattern and/or a particular code-derived pattern that triggered a notification or other action may receive negative feedback, decreasing the likelihood that the message or set of messages of the particular pattern or particular code-derived pattern will trigger a notification or other action for the user or group of users. In one example, this feedback would not impact whether other users or other groups of users see a notification for similar messages of the particular pattern or particular code-derived pattern, as the tuning of the model may be done on a per-user or per-group-of-users basis. In another example, this feedback impacts other users or other groups of users but not to the same level as the feedback impacts the user or group of users from which the feedback was received. In this manner, feedback may be weighted more for a user or group of users that provided the feedback than for other users. In one embodiment, based on feedback from a first user or group of users, a second user or group of users is prompted for additional feedback on whether the positive or negative view of a particular pattern of messages or a particular code-derived pattern should be treated as anomalous or not for notification purposes. The additional feedback received may cause the tuning from the first user or group of users to propagate to tuning for the second user or group of users.

In one embodiment, the tuning is performed in a traceable manner such that a message or set of messages that did not trigger an anomaly notification can be traced back to feedback from a particular user indicating that messages having the pattern or code-derived pattern of the message should not trigger an anomaly notification.

Feedback may be provided on a per-message basis or in a user interface that allows users to provide feedback on a plurality of messages. The plurality of messages may be shown along with shading or coloring to indicate whether the messages are being treated as action-worthy anomalies or non-action-worthy messages. The user may provide feedback to change messages marked as action-worthy anomalies to non-action-worthy messages and/or feedback to change messages marked as non-action-worthy messages to action-worthy anomalies. This feedback may be used to tune or train the model, on a per user or group basis, or for the model as a whole.

### Automatic Action Responsive to Anomalies

In one embodiment, a notification is sent to one or more users registered to be alerted in the case of an anomaly. For example, the notification may be sent via email, text message, or as a notification displayed in a user interface of an application. In one example, a notification is provided on a graphical user interface showing rows of messages or summaries of messages, indicating which message(s) are anomalous and which message(s) are not anomalous. In a particular embodiment, the graphical user interface shows a timeline of anomalies detected with options to drill into the message(s) associated with each anomaly. A selection to drill into the messages may result in a display of a set of messages associated with the selected anomaly, as well as general information about the anomaly and labels or classifications associated with the anomaly.

In one embodiment, the user interface includes a list of items such as messages or message patterns along with a suggested label as anomalous, non-anomalous, or neutral for each of the items. The anomalous messages may be colored differently than the non-anomalous messages and the neutral messages, and the user interface may also provide an option to mark messages as anomalous, non-anomalous, or neutral. A marking of neutral indicates that the message may or may not be a notification-worthy anomaly. Once items have been marked with user feedback, the user interface may include a button to submit the feedback.

The feedback may identify the file for which the feedback was submitted, a source, component, or type of the message, a path where the message is located, a username of a user who provided the feedback, a line number of the message in the file, a message content, a marking of whether the feedback marked the item as anomalous, non-anomalous, or neutral, and/or a timestamp of the feedback. The feedback may be consumed to update the model to improve user-specific, tenant-specific, or generic anomaly determinations.

In one embodiment, for certain anomalies with known solutions, the system manager triggers remediation of a system condition reflected by the anomaly to return the system condition to a non-anomalous state. For example, the system manager may restart specific resources that are non-responsive or not operating correctly, allocate more resources of specific types that are needed, or change a configuration setting to reflect a different mode of operation that has been detected.

### Computer System Architecture

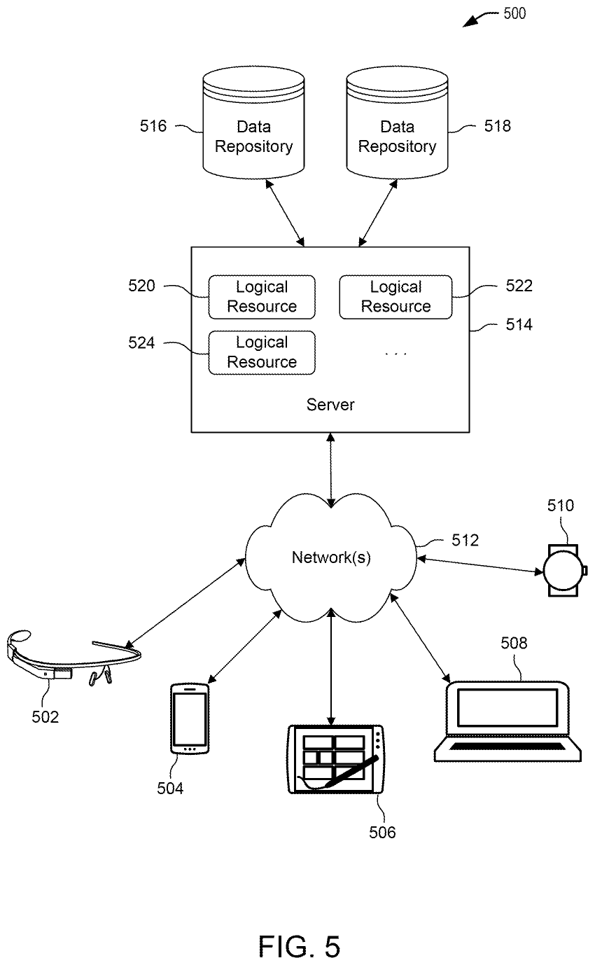

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for using code-derived message patterns to determine whether or not to trigger an anomaly notification.

In certain aspects, server 514 may also provide other services or software applications that can include non-virtual and virtual environments. In some aspects, these services may be offered as web-based or cloud services, such as under a Software as a Service (Saas) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for using code-derived message patterns to determine whether or not to trigger an anomaly notification in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, smart watches, smart glasses, or other wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, Apple Watch®, Meta Quest®, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 514 may be composed of one or more general purpose computers, specialized server computers (including, by way of example, PC (personal computer) servers, UNIX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for using code-derived message patterns to determine whether or not to trigger an anomaly notification. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

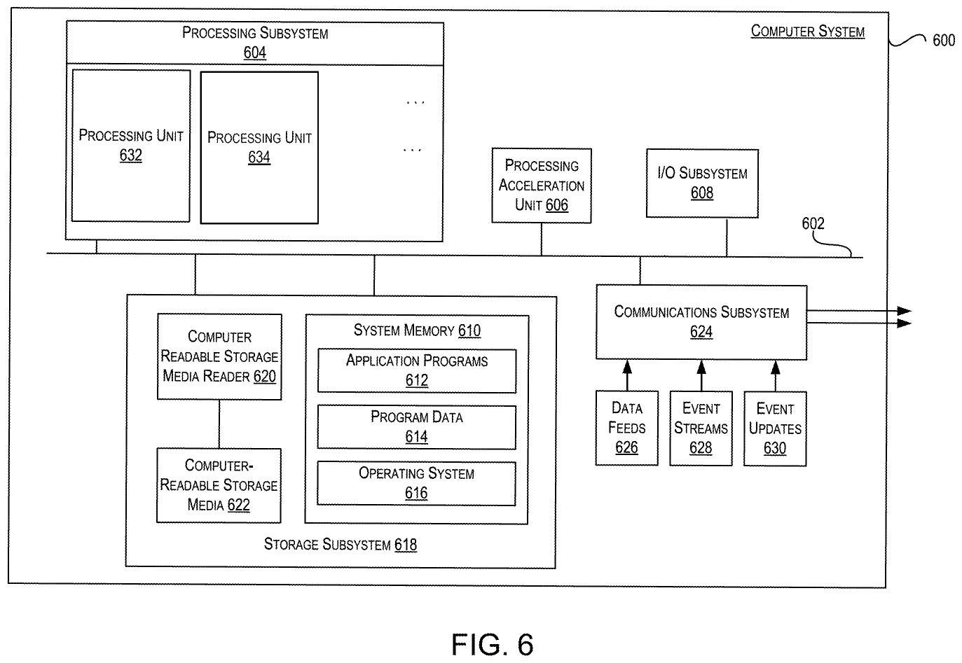

FIG. 6 illustrates an exemplary computer system 600 that may be used to implement certain aspects. For example, in some aspects, computer system 600 may be used to implement any of the system 100 for enriching log records with fields from other log records in structured format as shown in FIG. 1 and various servers and computer systems described above. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative aspects of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may include be single core or multicore processors. The processing resources of computer system 600 can be organized into one or more processing units 632, 634, etc. A processing unit may include one or more processors, one or more cores from the same or different processors, a combination of cores and processors, or other combinations of cores and processors. In some aspects, processing subsystem 604 can include one or more special purpose co-processors such as graphics processors, digital signal processors (DSPs), or the like. In some aspects, some or all of the processing units of processing subsystem 604 can be implemented using customized circuits, such as application specific integrated circuits (ASICs), or field programmable gate arrays (FPGAs).

In some aspects, the processing units in processing subsystem 604 can execute instructions stored in system memory 610 or on computer readable storage media 622. In various aspects, the processing units can execute a variety of programs or code instructions and can maintain multiple concurrently executing programs or processes. At any given time, some or all of the program code to be executed can be resident in system memory 610 and/or on computer-readable storage media 622 including potentially on one or more storage devices. Through suitable programming, processing subsystem 604 can provide various functionalities described above. In instances where computer system 600 is executing one or more virtual machines, one or more processing units may be allocated to each virtual machine.

In certain aspects, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be a cathode ray tube (CRT), a flat-panel device, such as that using a light emitting diode (LED) display, a liquid crystal display (LCD) or plasma display, a projection device, a touch screen, a computer monitor and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some aspects. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide a repository for storing data used in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 622 may store programming and data constructs that provide the functionality of some aspects. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, digital video disc (DVD), a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 618 may also include a computer-readable storage media reader 620 that can further be connected to computer-readable storage media 622. Reader 620 may receive and be configured to read data from a memory device such as a disk, a flash drive, etc.

In certain aspects, computer system 600 may support virtualization technologies, including but not limited to virtualization of processing and memory resources. For example, computer system 600 may provide support for executing one or more virtual machines. In certain aspects, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices. For example, the communication subsystem may be used to transmit a response to a user regarding the inquiry for a Chabot.

Communication subsystem 624 may support both wired and/or wireless communication protocols. For example, in certain aspects, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 624 can provide wired network connectivity (e.g., Ethernet) in addition to or instead of a wireless interface.

Communication subsystem 624 can receive and transmit data in various forms. For example, in some aspects, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 624 may be configured to receive data in the form of continuous data streams, which may include event streams 628 of real-time events and/or event updates 630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
determining a plurality of code-derived message text patterns from one or more source code files that generate messages of one or more types, wherein determining the plurality of code-derived message text patterns comprises:
detecting message generating instructions in the one or more source code files that generate messages of the one or more types, and
determining that the message generating instructions generate messages according to the plurality of code-derived message text patterns, wherein one or more of the plurality of code-derived message text patterns comprise invariant text and placeholders for variable text;
receiving a set of one or more messages;
determining a particular message of the one or more messages is at least one type of the one or more types;
determining one or more code-derived message text patterns of the plurality of code-derived message text patterns available for the at least one type;
matching the particular message to a particular code-derived message text pattern of the one or more code-derived message text patterns;
determining whether the particular message is anomalous based at least in part on the one or more code-derived message text patterns; and
based at least in part on determining that the particular message is anomalous, triggering a notification that the particular message is anomalous.

2. The computer-implemented method of claim 1, wherein matching the particular message to the particular code-derived message text pattern of the one or more code-derived message text patterns comprises:
using a drain having a fixed maximum depth to determine a particular text pattern for the particular message, and
matching the particular text pattern to the particular code-derived message text pattern.

3. The computer-implemented method of claim 1, wherein matching the particular message to the particular code-derived message text pattern of the one or more code-derived message text patterns comprises:
using a first drain portion having a fixed maximum depth to determine a first particular text pattern for the particular message, wherein the first particular text pattern accounts for a first part of the particular message but not a second part of the particular message;
determining that the first particular text pattern matches two or more code-derived message text patterns including the particular code-derived message text pattern and another code-derived message text pattern;
using a second drain portion having a fixed maximum depth to determine a second particular text pattern for the particular message, wherein the second particular text pattern accounts for the second part of the particular message; and
determining that the second particular text pattern matches the particular code-derived message text pattern and not the other code-derived message text pattern.

4. The computer-implemented method of claim 1, wherein matching the particular message to the particular code-derived message text pattern of the one or more code-derived message text patterns comprises:
determining a particular text pattern for the particular message using a message classifier having a computational complexity that does not increase beyond a fixed maximum even though the message classifier classifies messages that have a variable length including a variable amount of invariant text and placeholders; and
matching the particular text pattern to the particular code-derived message text pattern.

5. The computer-implemented method of claim 1, wherein matching the particular message to the particular code-derived message text pattern of the one or more code-derived message text patterns comprises:
determining a first particular text pattern for the particular message using a first message classifier component having a computational complexity that does not increase beyond a fixed maximum even though the first message classifier component classifies messages that have a variable length including a variable amount of invariant text and placeholders; wherein the first particular text pattern accounts for a first content variability of the particular message but not a second content variability of the particular message;
determining that the first particular text pattern matches two or more code-derived message text patterns including the particular code-derived message text pattern and another code-derived message text pattern;
determining a second particular text pattern for the particular message using a second message classifier component having a computational complexity that does not increase beyond a fixed maximum even though the second message classifier component classifies messages that have a variable length including a variable amount of invariant text and placeholders; wherein the second particular text pattern accounts for the second content variability of the particular message; and
determining that the second particular text pattern matches the particular code-derived message text pattern and not the other code-derived message text pattern.

6. The computer-implemented method of claim 1, wherein matching the particular message to the particular code-derived message text pattern of the one or more code-derived message text patterns comprises:
determining a particular text pattern for the particular message, and
determining that the particular text pattern exists in a set of stored text patterns, wherein the set of stored patterns comprises a stored association between the particular text pattern and the particular code-derived message text pattern.

7. The computer-implemented method of claim 1, wherein matching the particular message to the particular code-derived message text pattern of the one or more code-derived message text patterns comprises:
determining a particular text pattern for the particular message using a message classifier having a computational complexity that does not increase beyond a fixed maximum even though the message classifier classifies messages that have a variable length including a variable amount of invariant text and placeholders; and
determining that the particular text pattern matches two or more code-derived message text patterns including the particular code-derived message text pattern and another code-derived message text pattern;
determining that the particular message does not include one or more items of invariant text in the other code-derived message text pattern.

8. The computer-implemented method of claim 1, wherein determining whether the particular message is anomalous based at least in part on the one or more code-derived message text patterns comprises:
determining that the one or more code-derived message text patterns infrequently occur among the plurality of code-derived message text patterns.

9. The computer-implemented method of claim 1, wherein determining whether the particular message is anomalous based at least in part on the one or more code-derived message text patterns comprises:
determining that the particular code-derived message text pattern is reporting an anomaly based at least in part on a label generated by prompting a large language model to label the particular message, the particular code-derived message text pattern, or particular message generating instructions of the message generating instructions.

10. The computer-implemented method of claim 1, wherein determining whether the particular message is anomalous based at least in part on the one or more code-derived message text patterns comprises:
determining that the one or more code-derived message text patterns have been stored in a set of code-derived message text patterns that are marked as anomalous.

11. A computer-program product comprising one or more non-transitory machine-readable storage media, including stored instructions configured to cause a computing system to perform a set of actions including:
determining a plurality of code-derived message text patterns from one or more source code files that generate messages of one or more types, wherein determining the plurality of code-derived message text patterns comprises:
detecting message generating instructions in the one or more source code files that generate messages of the one or more types, and
determining that the message generating instructions generate messages according to the plurality of code-derived message text patterns, wherein one or more of the plurality of code-derived message text patterns comprise invariant text and placeholders for variable text;
receiving a set of one or more messages;
determining a particular message of the one or more messages is at least one type of the one or more types;
determining one or more code-derived message text patterns of the plurality of code-derived message text patterns available for the at least one type;
matching the particular message to a particular code-derived message text pattern of the one or more code-derived message text patterns;
determining whether the particular message is anomalous based at least in part on the one or more code-derived message text patterns; and
based at least in part on determining that the particular message is anomalous, triggering a notification that the particular message is anomalous.

12. The computer-program product of claim 11, wherein matching the particular message to the particular code-derived message text pattern of the one or more code-derived message text patterns comprises:
using a drain having a fixed maximum depth to determine a particular text pattern for the particular message, and
matching the particular text pattern to the particular code-derived message text pattern.

13. The computer-program product of claim 11, wherein matching the particular message to the particular code-derived message text pattern of the one or more code-derived message text patterns comprises:
using a first drain portion having a fixed maximum depth to determine a first particular text pattern for the particular message, wherein the first particular text pattern accounts for a first part of the particular message but not a second part of the particular message;
determining that the first particular text pattern matches two or more code-derived message text patterns including the particular code-derived message text pattern and another code-derived message text pattern;
using a second drain portion having a fixed maximum depth to determine a second particular text pattern for the particular message, wherein the second particular text pattern accounts for the second part of the particular message; and
determining that the second particular text pattern matches the particular code-derived message text pattern and not the other code-derived message text pattern.

14. The computer-program product of claim 11, wherein determining whether the particular message is anomalous based at least in part on the one or more code-derived message text patterns comprises:
determining that the one or more code-derived message text patterns infrequently occur among the plurality of code-derived message text patterns.

15. The computer-program product of claim 11, wherein determining whether the particular message is anomalous based at least in part on the one or more code-derived message text patterns comprises:
determining that the particular code-derived message text pattern is reporting an anomaly based at least in part on a label generated by prompting a large language model to label the particular message, the particular code-derived message text pattern, or particular message generating instructions of the message generating instructions.

16. A system comprising:
one or more processors;
one or more non-transitory computer-readable media storing instructions, which, when executed by the system, cause the system to perform a set of actions including:
determining a plurality of code-derived message text patterns from one or more source code files that generate messages of one or more types, wherein determining the plurality of code-derived message text patterns comprises:
detecting message generating instructions in the one or more source code files that generate messages of the one or more types, and
determining that the message generating instructions generate messages according to the plurality of code-derived message text patterns, wherein one or more of the plurality of code-derived message text patterns comprise invariant text and placeholders for variable text;
receiving a set of one or more messages;
determining a particular message of the one or more messages is at least one type of the one or more types;
determining one or more code-derived message text patterns of the plurality of code-derived message text patterns available for the at least one type;
matching the particular message to a particular code-derived message text pattern of the one or more code-derived message text patterns;
determining whether the particular message is anomalous based at least in part on the one or more code-derived message text patterns; and
based at least in part on determining that the particular message is anomalous, triggering a notification that the particular message is anomalous.

17. The system of claim 16, wherein matching the particular message to the particular code-derived message text pattern of the one or more code-derived message text patterns comprises:
using a drain having a fixed maximum depth to determine a particular text pattern for the particular message, and
matching the particular text pattern to the particular code-derived message text pattern.

18. The system of claim 16, wherein matching the particular message to the particular code-derived message text pattern of the one or more code-derived message text patterns comprises:
using a first drain portion having a fixed maximum depth to determine a first particular text pattern for the particular message, wherein the first particular text pattern accounts for a first part of the particular message but not a second part of the particular message;
determining that the first particular text pattern matches two or more code-derived message text patterns including the particular code-derived message text pattern and another code-derived message text pattern;
using a second drain portion having a fixed maximum depth to determine a second particular text pattern for the particular message, wherein the second particular text pattern accounts for the second part of the particular message; and
determining that the second particular text pattern matches the particular code-derived message text pattern and not the other code-derived message text pattern.

19. The system of claim 16, wherein determining whether the particular message is anomalous based at least in part on the one or more code-derived message text patterns comprises:
determining that the one or more code-derived message text patterns infrequently occur among the plurality of code-derived message text patterns.

20. The system of claim 16, wherein determining whether the particular message is anomalous based at least in part on the one or more code-derived message text patterns comprises:
determining that the particular code-derived message text pattern is reporting an anomaly based at least in part on a label generated by prompting a large language model to label the particular message, the particular code-derived message text pattern, or particular message generating instructions of the message generating instructions.
